(19) United States
(12) Patent Application Publication
(10) Pub. No.: US 2025/0240656 A1
(43) Pub. Date: Jul. 24, 2025

(54) Minimization of Drive Tests Measurement

(71) Applicant: Telefonaktiebolaget LM Ericsson (PUBL), Stockholm (SE)

(72) Inventors: Luca LUNARDI, GENOVA (IT); Ali PARICHEHREHTEROUJENI, LINKÖPING (SE); Pradeepa Ramachandra, LINKÖPING (SE)

(21) Appl. No.: 18/698,049

(22) PCT Filed: Sep. 26, 2022
(86) PCT No.: PCT/SE2022/050853

§ 371 Date: Apr. 3, 2024

Related U.S. Application Data
(60) Provisional application No. 63/262,194, filed on Oct. 7, 2021.

(51) Int. Cl. H04W 24/10; H04W 8/22; H04W 24/08

(52) U.S. Cl. CPC H04W 24/10; H04W 8/22; H04W 24/08

(57) ABSTRACT

A method performed by a Radio Access Node (RAN) node is provided. The method is for controlling a Minimization of Drive Tests (MDT) measurement to be performed by a User Equipment (UE) or a group of UEs in a wireless communications network. The RAN node obtains (601) a set of parameters of an MDT configuration. The set of parameters comprises respective one or more filtering criteria related to type of network support and/or UE characteristic and/or level of granularity. These are to be used by UEs for performing MDT measurements. The RAN node sends (603) an MDT configuration to a first UE or a group of UEs comprising the first UE. The MDT configuration comprises one or more parameters. The one or more parameters comprises at least a part of the parameters comprised in the set of parameters. The MDT configuration configures the first UE, or the group of UEs, to measure and report MDT measurements according to said filtering criteria.

### TECHNICAL FIELD

Embodiments herein relate to a User Equipment (UE), a Radio Access Node (RAN) node and methods therein. In some aspects, they relate to controlling a Minimization of Drive Tests (MDT) measurement to be performed by the UE or a group of UEs in a wireless communications network.

Embodiments herein further relates to computer programs and carriers corresponding to the above methods, UE, and RAN node.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a RAN part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G, 6G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### 5G RAN Architecture

FIG. 1 illustrates an overall architecture of Next Generation (NG)-RAN according to 3GPP TS 38.401 v16.6.0, FIG. 6.1-1.

The NG-RAN comprises of a set of gNBs connected to the 5th Generation Core network (5GC) through the NG interface.

As specified in 3GPP TS 38.300 v16.7.0, NG-RAN may also comprise of a set of ng-eNBs, an ng-eNB may comprise an ng-eNB-Central Unit (CU) and one or more ng-eNB-Distributed Units (DU)(s). An ng-eNB-CU and an ng-eNB-DU are connected via an W1 interface. The general principle described in this section also applies to ng-eNB and W1 interface, if not explicitly specified otherwise.

A gNBs may be interconnected through the Xn interface between the RAN nodes.

A gNB may comprise a gNB-CU and one or more gNB-DU(s). A gNB-CU and a gNB-DU is connected via F1 interface between a gNB-CU and a gNB-DU.

One gNB-DU is connected to only one gNB-CU.

NG, Xn and F1 are logical interfaces.

For NG-RAN, the NG and Xn-C interfaces for a gNB consisting of a gNB-CU and gNB-DUs, terminate in the gNB-CU. For EN-DC, the S1-U and X2-C interfaces for a gNB consisting of a gNB-CU and gNB-DUs, terminate in the gNB-CU. The gNB-CU and connected gNB-DUs are only visible to other gNBs and the 5GC as a gNB.

The overall architecture for separation of gNB-CU-Control Plane (CP) and gNB-CU-User Planes (UP) according to FIG. 6.1.2-1 in TS 38.401 v16.6.0 is illustrated in FIG. 2.

A gNB may comprise a gNB-CU-CP, multiple gNB-CU-UPs and multiple gNB-DUs; The gNB-CU-CP is connected to the gNB-DU through the F1-C interface between the gNB-CU-CP and the gNB-DU.

The gNB-CU-UP is connected to the gNB-DU through the F1-U interface between the gNB-CU-UP and gNB-DU.

The gNB-CU-UP is connected to the gNB-CU-CP through the E1 interface between the gNB-CU-CP and gNB-CU-UP.

One gNB-DU is connected to only one gNB-CU-CP;

One gNB-CU-UP is connected to only one gNB-CU-CP;

One gNB-DU may be connected to multiple gNB-CU-UP(s) under the control of the same gNB-CU-CP;

One gNB-CU-UP may be connected to multiple DUs under the control of the same gNB-CU-CP.

The overall architecture of IAB is depicted in FIG. 3. FIG. 3 depicts FIG. 6.1.3-1 in 3GPP TS 38.401 v16.6.0).

The NG-RAN supports Integrated Access and Backhaul (IAB) by the IAB-node wirelessly connecting to the gNB capable of serving the IAB-nodes, named IAB-donor.

The IAB-donor comprises an IAB-donor-CU and one or more IAB-donor-DU(s). In case of separation of gNB-CU-CP and gNB-CU-UP, the IAB-donor may comprise an IAB-donor-CU-CP, multiple IAB-donor-CU-UPs and multiple IAB-donor-DUs.

The IAB-node connects to an upstream IAB-node or an IAB-donor-DU via a subset of the UE functionalities of the NR Uu interface between the IAB donor-DU and IAB-node and also between IAB-node and another IAB-node, named IAB-MT function of IAB-node. The IAB-node provides wireless backhaul to the downstream IAB-nodes and UEs via the network functionalities of the NR Uu interface, named IAB-DU function of IAB-node.

The F1-C traffic between an IAB-node and IAB-donor-CU is backhauled via the IAB-donor-DU and the optional intermediate hop IAB-node(s).

The F1-U traffic between an IAB-node and IAB-donor-CU is backhauled via the IAB-donor-DU and the optional intermediate hop IAB-node(s).

### An Overview of Some RAN Characteristics

### High Speed Dedicated Network

High Speed Dedicated Network (HSDN) relates to a characteristic of the RAN. An HSDN cell is a cell with higher priority than other cells for cell reselection, as described e.g., in 3GPP TS 36.304 v16.4.0, clause 5.2.4.1

When a HSDN capable UE is in High-mobility state, the UE shall always consider the HSDN cells to be the highest priority (i.e. higher than any other network configured priorities). When the HSDN capable UE is not in High-mobility state, the UE shall always consider HSDN cells to be the lowest priority (i.e. lower than network configured priorities).

### Closed Subscribed Group

A Closed Subscriber Group (CSG) indicates a network characteristic identifying a specific group of cells that can be accessed. The E-UTRAN related Radio Resource Control (RRC) signalling is described e.g., in 3GPP TS 36.331 v16.5.0, clause 6.2.2.

### Non-Public Network

Non-Public networks (NPN) are intended for the sole use of a private entity such as an enterprise, and may be deployed in a variety of configurations, utilizing both virtual and physical elements. Specifically, they may be deployed as completely standalone networks, they may be hosted by a PLMN, or they may be offered as a slice of a PLMN.

As described in 3GPP TS 23.501 v17.1.1, clause, 5.30.1, a Non-Public Network (NPN) is a 5GS deployed for non-public use, and an NPN is either:
a Stand-alone Non-Public Network (SNPN), i.e. operated by an NPN operator and not relying on network functions provided by a PLMN, or
a Public Network Integrated NPN (PNI-NPN), i.e. a non-public network deployed with the support of a PLMN.

### Integrated Access Backhaul

An Integrated Access Backhaul (IAB) is a type of network support where IAB-node connects wirelessly to a gNB capable of serving the IAB-nodes, named IAB-donor.

The IAB-donor consists of an IAB-donor-CU and one or more IAB-donor-DU(s). In case of separation of gNB-CU-CP and gNB-CU-UP, the IAB-donor may consist of an IAB-donor-CU-CP, multiple IAB-donor-CU-UPs and multiple IAB-donor-DUs.

The IAB-node connects to an upstream IAB-node or an IAB-donor-DU via a subset of the UE functionalities of the NR Uu interface (named IAB-MT function of IAB-node). The IAB-node provides wireless backhaul to the downstream IAB-nodes and UEs via the network functionalities of the NR Uu interface (named IAB-DU function of IAB-node).

The overall architecture of IAB is shown e.g. in 3GPP TS 38.401 v16.4.0.

### Slicing Aspects

A Network Slice instance is defined within a PLMN. Network slices may differ for supported features and network functions optimisations, in which case such Network Slices may have e.g. different Single-Network Slice Selection Assistance Information (S-NSSAI)(s) with different Slice/Service Types. An S-NSSAI identifies a Network Slice, and it comprises:
A Slice/Service type (SST), which refers to the expected Network Slice behavior in terms of features and services;
A Slice Differentiator (SD), which is optional information that complements the Slice/Service type(s) to differentiate amongst multiple Network Slices of the same Slice/Service type.

Standardized SST values provide a way for establishing global interoperability for slicing, so that PLMNs can support the roaming use case more efficiently for the most commonly used Slice/Service Types. The standardised SSTs are described e.g., in 3GPP TS 23.501 v17.1.1, Table 5.15.2.2-1.

### Minimization of Drive Tests (MDT)

MDT was standardized for NR in 3GPP Release 16 to reduce the amount of drive tests performed manually. It is a UE assisted framework where network measurements are collected by both IDLE/INACTIVE and RRC Connected UE(s) in order to aid the network in gathering valuable information. It has been specified for both LTE and NE in 3GPP TS 37.320. v 16.6.0.

### MDT Types Based on RRC States

In general, there are two types of MDT measurement logging, i.e., Logged MDT and Immediate MDT.

### Logged MDT

A UE in RRC_IDLE/RRC_INACTIVE state is configured to perform periodical, and event triggered MDT logging after receiving the MDT configurations from the network. The UE shall report the DL pilot strength measurements (RSRP/RSRQ) together with time information, detailed location information if available, and WLAN, Bluetooth to the network via using the UE information framework when it is in RRC_CONNECTED state. The DL pilot strength measurement of Logged MDT is collected based on the existing measurements required for cell reselection purpose, without imposing UE to perform additional measurements.

Table 1 comprises the measurement logging for Logged MDT—

TABLE 1

| MDT | | |
|---|---|---|
| mode | RRC states | Measurement quantities |
| Logged | RRC_IDLE/RRC_INACTIVE | RSRP and RSRQ of the serving |
| MDT | | cell and available UE measurements |
| | | for intra-frequency/inter-frequency/ |
| | | inter-RAT, time stamp and detailed |
| | | location information if available. |

For Periodical Logged MDT, UE receives the MDT configurations including logginginterval and loggingduration in the RRC message, i.e., LoggedMeasurementConfiguration, from the network. A timer (T330) is started at the UE upon receiving the configurations and set to loggingduration (10 min-120 min). The UE shall perform periodical MDT logging with the interval set to logginginterval (1.28 s-61.44 s) when the UE is in RRC_IDLE. An example of the MDT logging is shown in the FIG. 4.

For event triggered Logged MDT, the UE receives eventType and logginginterval from the network. The UE logs the measurement reports at every logging interval if event configured in event Type is satisfied.

### MDT Configurations

An example of MDT configuration for NR and for E-UTRAN are provided in the tables below, extracted from 3GPP TS 38.423 v16.6.0, clause 9.2.3.126 and 9.2.3.127.

### 9.2.3.126 MDT Configuration—NR

The IE defines the MDT configuration parameters of NR.

| | | | IE type and | Semantics |
|---|---|---|---|---|
| IE/Group Name | Presence | Range | reference | description |
| MDT Activation | M | | ENUMERATED | |
| | | | (Immediate MDT only, | |
| | | | Logged MDT only, | |
| | | | Immediate MDT and | |
| | | | Trace, . . . ) | |
| CHOICE Area Scope | O | | | |
| of MDT-NR | | | | |
| >Cell based | | | | |
| >>Cell ID List for | | 1 . . . | | |
| MDT-NR | | <maxnoofCellIDforMDT> | | |
| >>>NR CGI | M | | 9.2.2.7 | |
| >TA based | | | | |
| >>TA List for | | 1 . . . | | |
| MDT | | <maxnoofTAforMDT> | | |
| >>>TAC | M | | OCTET STRING | The TAI is derived using |
| | | | (SIZE (3)) | the current serving PLMN. |
| >TAI based | | | | |
| >>TAI List for | | 1 . . . | | |
| MDT | | <maxnoofTAforMDT> | | |
| >>>TAI | M | | 9.2.3.20 | |
| CHOICE MDT Mode | M | | | |
| >immediate MDT- | | | | |
| NR | | | | |
| >>Measurements | M | | BITSTRING | Each position in the bitmap indicates a MDT |
| to Activate | | | (SIZE(8)) | measurement, as defined in TS 37.320 [43]. |
| | | | | First Bit = M1, |
| | | | | Second Bit = M2, |
| | | | | Fourth Bit = M4, |
| | | | | Fifth Bit = M5, |
| | | | | Sixth Bit = logging of M1 from event triggered |
| | | | | measurement reports according to existing RRM |
| | | | | configuration, |
| | | | | Seventh Bit = M6, |
| | | | | Eighth Bit = M7. |
| | | | | Value “1” indicates “activate” and value “0” |
| | | | | indicates “do not activate”. |
| | | | | This version of the specification does not use |
| | | | | bits 3. |
| >>M1 | C-ifM1 | | 9.2.3.128 | |
| Configuration | | | | |
| >>M4 | C-ifM4 | | 9.2.3.129 | |
| Configuration | | | | |
| >>M5 | C-ifM6 | | 9.2.3.130 | |
| Configuration | | | | |
| >>MDT Location | O | | BITSTRING(SIZE(8)) | Each position in the bitmap represents requested |
| Information | | | | location information as defined in TS 37.320 [43]. |
| | | | | First Bit = GNSS |
| | | | | Other bits are reserved for future use and are |
| | | | | ignored if received. |
| | | | | Value “1” indicates “activate” and value “0” |
| | | | | Indicates “do not activate”. |
| | | | | The eNB shall ignore the first bit unless the |
| | | | | Measurements to Activate IE has the first bit or |
| | | | | the sixth bit set to “1”. |
| >>M6 | C-ifM6 | | 9.2.3.131 | |
| Configuration | | | | |
| >>M7 | C-ifM7 | | 9.2.3.132 | |
| Configuration | | | | |
| >>Bluetooth | O | | 9.2.3.11 | |
| Measurement | | | | |
| Configuration | | | | |
| >>WLAN | O | | 9.2.3.12 | |
| Measurement | | | | |
| Configuration | | | | |
| >>Sensor | O | | 9.2.3.136 | |
| Measurement | | | | |
| Configuration | | | | |
| >Logged MDT-NR | | | | |
| >>Logging interval | M | | ENUMERATED | This IE is defined in |
| | | | (ms 320, ms 640, | TS 38.331 [10]. The value |
| | | | ms 1280, ms 2560, | “infinity” represents one shot |
| | | | ms 5120, ms 10240, | logging, i.e., only one log per |
| | | | ms 20480, ms 30720, | event in the logged MDT report. |
| | | | ms 40960 and ms 61440, | |
| | | | infinity) | |
| >>Logging | M | | ENUMERATED (10, 20, | This IE is defined in |
| duration | | | 40. 60, 90, 120) | TS 38.331 [10]. Unit: [minute]. |
| >>CHOICE Report | M | | | |
| Type | | | | |
| >>>Periodical | | | | |
| >>>Event | | | | |
| Triggered | | | | |
| >>>>Logged | M | | 9.2.3.137 | |
| Event Trigger | | | | |
| Config | | | | |
| >>Bluetooth | O | | 9.2.3.134 | |
| Measurement | | | | |
| Configuration | | | | |
| >>WLAN | O | | 9.2.3.135 | |
| Measurement | | | | |
| Configuration | | | | |
| >>Sensor | O | | 9.2.3.136 | |
| Measurement | | | | |
| Configuration | | | | |
| >>Area Scope of | O | | 9.2.3.140 | |
| Neighbour Cells | | | | |
| Signalling based MDT | O | | MDT PLMN List | |
| PLMN List | | | 9.2.3.133 | |

| Range bound | Explanation |
|---|---|
| maxnoofCellIDforMDT | Maximum no. of Cell ID subject |
| | for MDT scope. Value is 32. |
| maxnoofTAforMDT | Maximum no. of TA subject for |
| | MDT scope. Value is 8. |

| Condition | Explanation |
|---|---|
| C-ifM1 | This IE shall be present if the Measurements |
| | to Activate IE has the first bit set to “1”. |
| C-ifM4 | This IE shall be present if the Measurements |
| | to Activate IE has the fourth bit set to “1”. |
| C-ifM5 | This IE shall be present if the Measurements |
| | to Activate IE has the fifth bit set to “1”. |
| C-ifM6 | This IE shall be present if the Measurements |
| | to Activate IE has the seventh bit set to “1”. |
| C-ifM7 | This IE shall be present if the Measurements |
| | to Activate IE has the eighth bit set to “1”. |

### 3GPP 9.2.3.127 MDT Configuration—EUTRA

The IE defines the MDT configuration parameters of EUTRA.

| | | | IE type and | Semantics |
|---|---|---|---|---|
| IE/Group Name | Presence | Range | reference | description |
| MDT Activation | M | | ENUMERATED(Immediate | |
| | | | MDT only, Logged MDT | |
| | | | only, Immediate MDT and | |
| | | | Trace, . . . ) | |
| CHOICE Area Scope of | O | | | |
| MDT-E-UTRA | | | | |
| >Cell based | | | | |
| >>Cell ID List for MDT | | 1 . . . | | |
| | | <maxnoofCellIDforMDT> | | |
| >>>NR CGI | M | | 9.2.2.7 | |
| >TA based | | | | |
| >>TA List for MDT | | 1 . . . | | |
| | | <maxnoofTAforMDT> | | |
| >>>TAC | M | | OCTET STRING | The TAI is derived using |
| | | | (SIZE (3)) | the current serving |
| | | | | PLMN. |
| >TAI based | | | | |
| >>TAI List for MDT | | 1 . . . | | |
| | | <maxnoofTAforMDT> | | |
| >>>TAI | M | | 9.2.3.20 | |
| MDT Mode E-UTRA | M | | OCTET STRING | MDTMode IE defined in |
| | | | | TS 36.413 [16]. |
| Signalling based MDT | O | | MDT PLMN List | |
| PLMN List | | | 9.2.3.133 | |

| Range bound | Explanation |
|---|---|
| maxnoofCellIDforMDT | Maximum no. of Cell ID subject |
| | for MDT scope. Value is 32. |
| maxnoofTAforMDT | Maximum no. of TA subject |
| | for MDT scope. Value is 8. |

### SUMMARY

An object of embodiments herein is e.g. to improve the flexibility of MDT configurations.

According to an aspect, the object is achieved by a method performed by a Radio Access Node, RAN, node. The method is for controlling a Minimization of Drive Tests (MDT) measurement to be performed by a User Equipment, UE, or a group of UEs in a wireless communications network. The RAN node obtains a set of parameters of an MDT configuration. The set of parameters comprises respective one or more filtering criteria related to type of network support and/or UE characteristic and/or level of granularity. These are to be used by UEs for performing MDT measurements. The RAN node sends an MDT configuration to a first UE or a group of UEs comprising the first UE. The MDT configuration comprises one or more parameters. The one or more parameters comprises at least a part of the parameters comprised in the set of parameters. The MDT configuration configures the first UE, or the group of UEs, to measure and report MDT measurements according to said filtering criteria.

According to another aspect, the object is achieved by a method. The method is performed by a User Equipment, UE. The method is for handling a Minimization of Drive Tests (MDT) measurement in a wireless communications network. The UE receives an MDT configuration from a Radio Access Node, RAN, node. The MDT configuration comprises one or more parameters comprising respective one or more filtering criteria related to type of network support and/or UE characteristic and/or level of granularity. These are to be used by the UE for performing MDT measurements. The MDT configuration configures the UE to measure and report MDT measurements according to said filtering criteria.

According to another aspect, the object is achieved by a Radio Access Node, RAN, node. The RAN node is configured to control a Minimization of Drive Tests, MDT, measurement to be performed by a User Equipment, UE, or a group of UEs in a wireless communications network. The RAN node is configured to:
obtain a set of parameters of an MDT configuration. The set of parameters is adapted to comprise respective one or more filtering criteria related to type of network support and/or UE characteristic and/or level of granularity. These are to be used by UEs for performing MDT measurements.
send an MDT configuration to a first UE or a group of UEs comprising the first UE. The MDT configuration comprises one or more parameters. The one or more parameters are adapted to comprise at least a part of the parameters comprised in the set of parameters. The MDT configuration is adapted to configure the first UE, or the group of UEs, to measure and report MDT measurements according to said filtering criteria. According to another aspect, the object is achieved by a User Equipment, UE. The UE is configured to handle a Minimization of Drive Tests (MDT) measurement in a wireless communications network. The UE is further configured to:
receive an MDT configuration from a Radio Access Node, RAN, node. The MDT configuration comprises one or more parameters. The one or more parameters are adapted to comprise respective one or more filtering criteria related to type of network support and/or UE characteristic and/or level of granularity. These are to be used by the UE for performing MDT measurements. The MDT configuration is adapted to configure the UE to measure and report MDT measurements according to said filtering criteria.

Thanks to that the RAN node obtains the MDT configuration, indicating the filtering criteria to use in determining whether the UE or a group of UE(s) is (are) eligible for MDT measurements, the RAN node is enabled to send at least part of said parameters comprising the filtering criteria to the UE as part of the MDT configuration over the air interface. This results in that the first UE, or the group of UEs, is (are) configured to measure and report MDT measurements according to said filtering criteria. This in turn improves the flexibility of MDT configurations.

Some advantages of embodiments herein e.g., comprise:

Embodiments herein enhance the flexibility of MDT configuration which e.g. gives a network operator a better control of granularity of MDT measurements collection, by e.g. using various filtering options related to network support and UE type, UE category or UE behavior.

### BIEF DESCRIPTION OF THE DRAWINGS

FIG. 1 is a schematic block diagram depicting an example of prior art.

FIG. 2 is a schematic block diagram depicting an example of prior art.

FIG. 3 is a schematic block diagram depicting an example of prior art.

FIG. 4 is a schematic block diagram depicting an example of prior art.

FIG. 5 is a schematic block diagram depicting embodiments of a wireless communications network.

FIG. 6 is a flow chart depicting embodiments of a method in a RAN node.

FIG. 7 is a flow chart depicting embodiments of a method in a UE.

FIGS. 8 a and b are schematic block diagrams depicting embodiments of a RAN node.

FIGS. 9 a and b are schematic block diagrams depicting embodiments of a UE.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12 to 15 are flowcharts illustrating methods implemented in a communication system including a host computer, a base station and a user equipment.

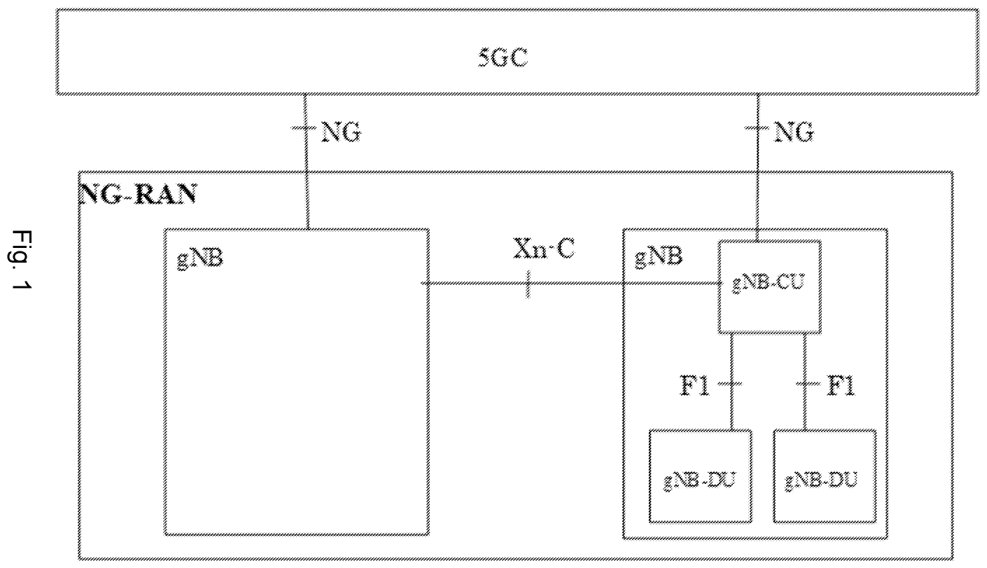

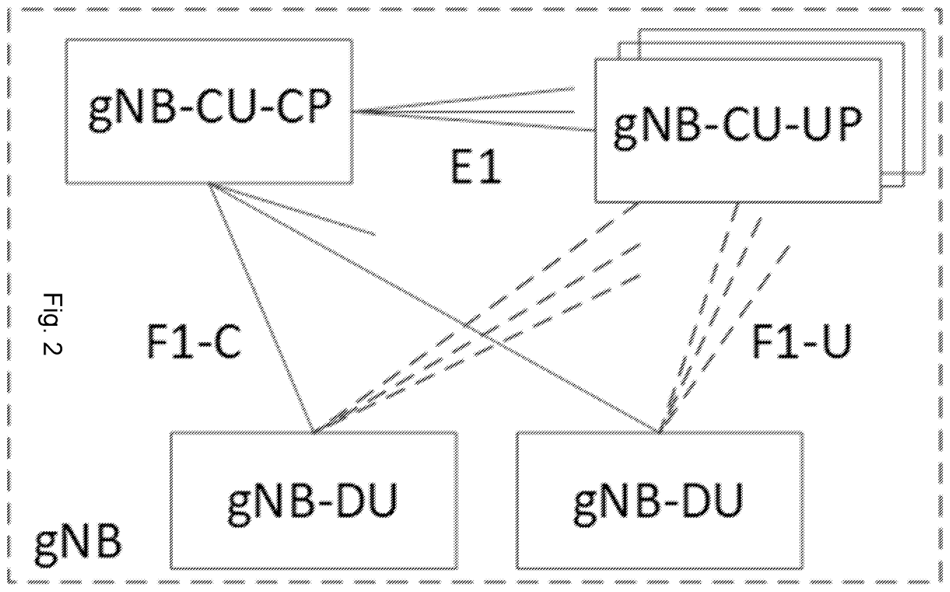

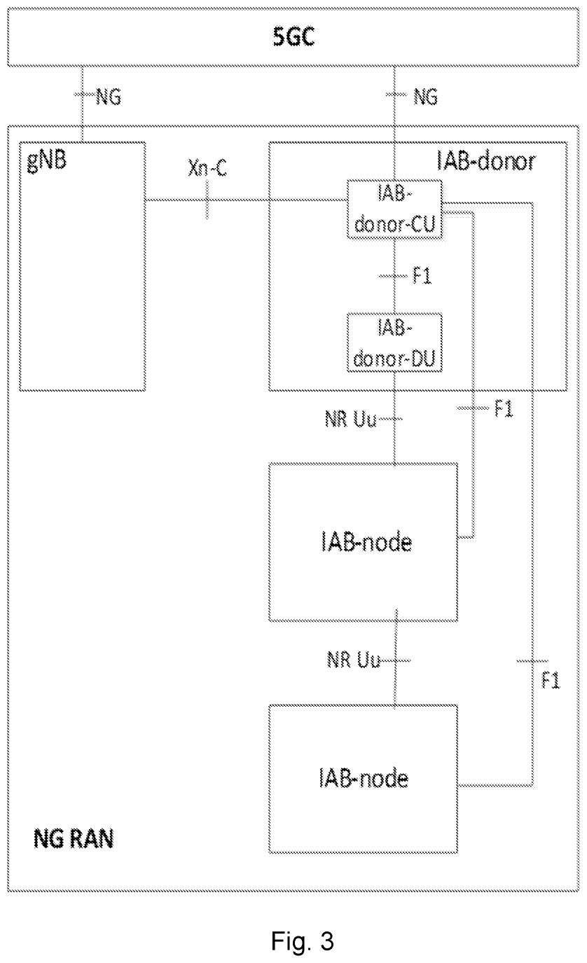

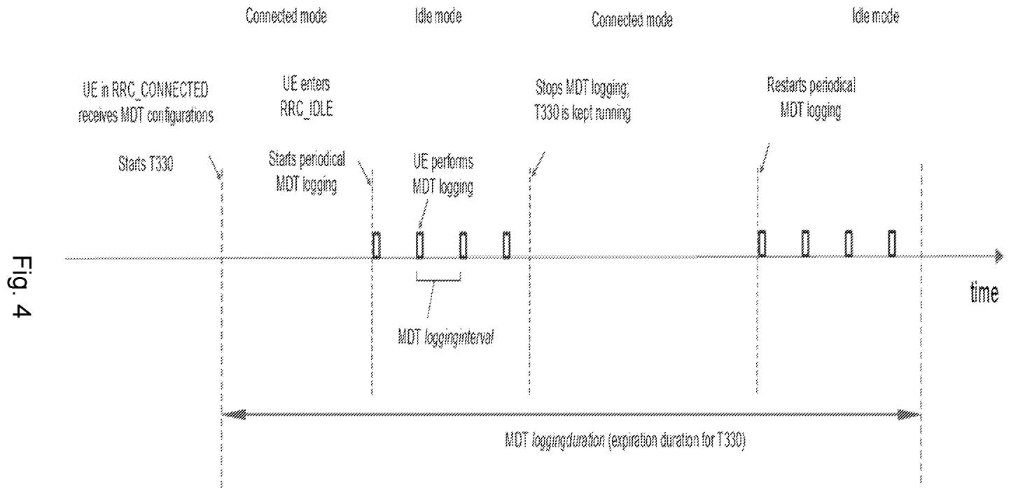

### DETAILED DESCRIPTION

As a part of developing embodiments herein the inventors identified a problem which first will be shortly discussed.

A problem identified with existing solutions is the lack of flexibility in the MDT Configuration with respect to the scope of MDT measurements collection. This may lead to effects such as the collection of MDT measurements that are of no interest, the sending of unnecessary data over the air interface with an increase in interference in the link between the UE and a RAN node, and the need for a post-collection tool to reduce the collected data only to the ones that are required.

An object of embodiments herein is to improve the flexibility of MDT configurations in a wireless communications network.

Embodiments herein provide flexibility of MDT configurations. A flexible MTD configuration when used herein may mean an MDT configuration that allows to control different dimensions according to which the collection of data can be focused. In example embodiments herein, to be more flexible an MDT configuration is extended by including filtering criteria that may be used by a UE or to select a UE for configuring and reporting MDT measurements. The flexibility of the MDT configurations is achieved e.g. by considering said filtering criteria such as e.g. certain type(s) of support, or excluding certain type(s) of support, at different level of granularities, e.g. at network level, at RAN node level, at Tracking Area level, at cell level, for performing and/or reporting MDT measurements.

One example of advantages of embodiments herein is that the flexibility of MDT configuration is enhanced which e.g. gives a network operator a better control of granularity of MDT measurements collection, by e.g. using various filtering options related to network support and UE type, UE category or UE behavior.

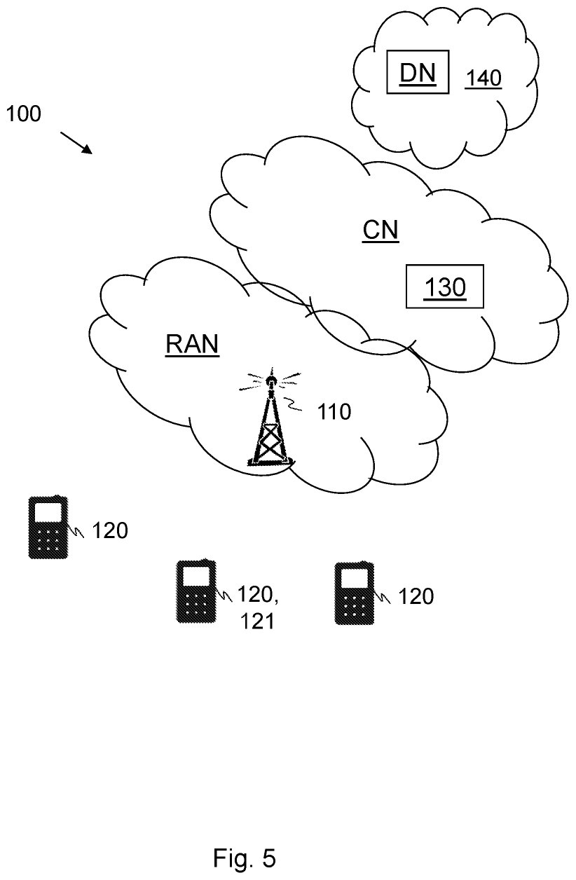

FIG. 5 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, LTE, LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a RAN node 110 operate in the wireless communications network 100. The RAN node 110 may e.g. provide a cell or a number of cells and may use these cells for communicating with e.g. one or more UEs 120, 121. The RAN node 110, may respectively be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the RAN node 110, depending e.g. on the radio access technology and terminology used.

UEs operate in the wireless communications network 100, such as UEs 120, whereof one UE 120 is referred to as a UE 121. Further, in some embodiments, it is referred to a group of UEs 120 121. The group of UEs may comprise one or more UEs e.g. the UEs 120, 121. The UE 121 is also referred to as the first UE 121 just to be able to identify the UE 121 in the group of UEs 120, 121.

Each respective UE out of the group of UEs 120, 121, such as the first UE 121, may be configured to communicate with the RAN node 110. Each respective UE out of the group of UEs 120, 121, such as the first UE 121, may further be configured to receive MDT configurations from the RAN node 110,

Each respective UE out of the group of UEs 120, 121, such as the first UE 121, may e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the RAN node 110, one or more Access Networks (AN), e.g. RAN, to one or more core networks (CN). It should be understood by the skilled in the art that the term UE as used herein relates to a non-limiting term which means any UE, wireless terminal, wireless communication terminal, any vehicle unit comprising wireless communication means, user equipment, (D2D) terminal, or node e.g. smart phone, laptop, mobile phone, sensor, relay, mobile tablets or even a small base station communicating within a cell.

Further, network nodes such as e.g. a network node 130 operate in the wireless communications network 100. The network node 130 may e.g. another RAN node, a CN node, an Operations, Administration and Maintenance (OAM) node, an Service Management and Orchestration (SMO) node, any other network unit capable of communicating with the RAN node 110.

Methods herein may in some aspects be performed by the RAN node 110 and/or the UE 121. As an alternative, a Distributed Node (DN) and functionality, e.g. comprised in a cloud 140 as shown in FIG. 5, may be used for performing or partly performing the methods.

As hinted above, embodiments herein provide an MDT configuration that is extended compared to prior art, by including additional filtering criteria to be use in the selection of UEs 120, 121 when configuring MDT measurements, or to be used by the UEs 120, 121 when performing MDT measurements. One or more filtering criteria or identifiers associated to filtering criteria may be comprised both within an MDT configuration and MDT

The flexibility of the MDT configurations is achieved e.g. by considering said filtering criteria such as e.g. certain type(s) of support (or excluding certain type(s) of support) at different level of granularities, e.g. at network level, at RAN node level, at Tracking Area level, at cell level, for performing and/or reporting MDT measurements.

In a possible example, an MDT configuration may comprise a criterion, also referred to as a filter or a scope, so that the UEs 120, 121 are configured for MDT measurements only in case High Speed Data Network, or alike, is supported within a selected Area, such as e.g. a PLMN, or a Tracking Area, or a list of cells.

In another possible example, an MDT configuration may comprise a criterion indicating the UE type or category so that UEs 120, 121 from specific type or category may perform MDT measurements if configured or be chosen and configured by the RAN node for MDT measurements.

The RAN node 110 may receive from another network node 130 (such as a RAN node, a CN node, an OAM node, an SMO node) a set of parameters, (e.g. comprising one of more parameters) within an MDT configuration. The parameters in the set of parameters indicate respective filtering criteria to use, e.g. in determining whether a UE or a group of UE(s) is (are) eligible for MDT measurements. The RAN node 110 may send at least part of said set of parameters, to the UE 120, 121 or group of UEs 120, 121 as part of MDT configuration over the air interface. The at least part of said set of parameters means one or more parameters that are comprised in at least a part of the parameters in the set of parameters. The RAN node 110 may further receive the MDT measurements concerning at least part of said parameters from a UE such as the UE 120, 121 as part of an MDT reporting.

Note that in the above description the MDT configuration may be any type of configurations such as immediate or logged MDT configuration, combined with management based and/or signaling based MDT.

Such a configuration may be configured in terms of the filter (scope) criterion configuration or in terms of events. For example, an event configuration may be associated to upon being served by a HSDN cell.

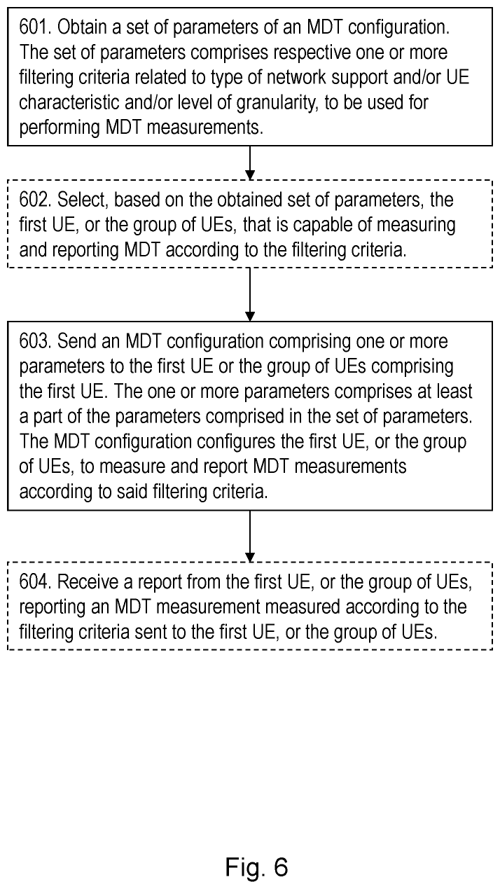

FIG. 6 shows an example method performed by the RAN node 110, e.g. for controlling an MDT measurement to be performed by a UE 120, 121 or a group of UEs 120, 121, such as e.g. the first UE 121, in the wireless communications network 100. The method may comprise any one or more out of the actions below. The following actions may be performed in any suitable order.

### Action 601

The RAN node 110 obtains a set of parameters of an MDT configuration, e.g. from the network node 130. The set of parameters comprises respective one or more filtering criteria related to type of network support and/or UE characteristic and/or level of granularity, to be used by UEs 120, 121 for performing MDT measurements.

A filtering criteria when used herein e.g. means that data to be collected are those that fulfil the conditions indicated by the filtering criteria

In some embodiments, the one or more filtering criteria, related to type of network support and/or UE characteristic and/or level of granularity, relate to any one or more out of:
a High Speed Data Network, HSDN, and/or indications or conditions pertaining to speed,
a value or range of values of UE velocity,
an NR-R or NR-Railway indication,
a UE type or UE category,
a Closed Subscribed Group CSG,
Mobility Restrictions,
a Type of Core Network e.g. Evolved Packet Core (EPC) or 5GC,
a Non-Public Network,
a Public Warning System PWS,
an Integrated Access and Backhaul, IAB,
a Slice, e.g. one or a list of S-NSSAIs, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
an Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT.

In some embodiments, the MDT configuration further comprises to apply the MDT measurement and send the MDT measurement report according to any one or more out of:
Per MDT mode,
per MDT measurements,
per “Area Scope of MDT” value, and
per “event configuration”.

### Action 602

In some embodiments, the RAN node 110 selects the first UE 121, or the group of UEs 120, 121, that is capable of measuring and reporting MDT according to the filtering criteria. In these embodiments, the RAN node 110 selects the first UE 121, or the group of UEs 120, 121 based on the obtained set of parameters.

### Action 603

The RAN node 110 sends an MDT configuration to the first UE 121 or the group of UEs 120, 121 comprising the first UE 121. The MDT configuration comprising one or more parameters. The one or more parameters comprises at least a part of the parameters comprised in the set of parameters. The MDT configuration configures the first UE 121, or the group of UEs 120, 121, to measure and report MDT measurements according to said filtering criteria.

In some embodiments, the MDT configuration further configures the first UE 121, or the group of UEs 120, 121, e.g. to evaluate, to determine whether and/or when the first UE 121, or the group of UEs 120, 121, should perform MDT measurements filtered according to the filtering criteria. This may mean that the MDT configuration further configures the first UE 121, or the group of UEs 120, 121 to determine whether and/or when the first UE 121, or the group of UEs 120, 121, should perform MDT measurements filtered according to the filtering criteria.

### Action 604

In some embodiments, the RAN node 110 receives a report from the first UE 121, or the group of UEs 120, 121. The report comprises an MDT measurement measured according to the filtering criteria that was sent to the first UE 121, or the group of UEs 120, 121. The report may further comprise the filtering criteria used for filtering the reported MDT measurement. This may be to inform the RAN node 110 of which filtering criteria that was used for filtering the reported MDT measurement.

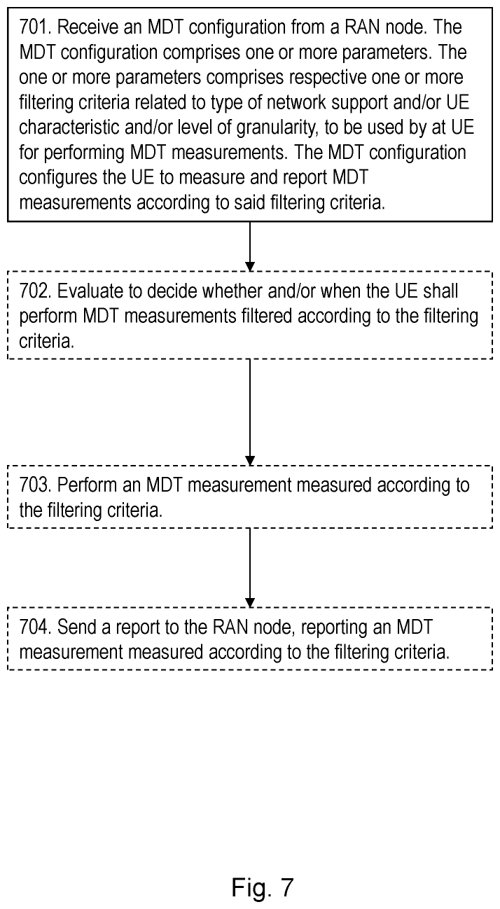

FIG. 7 shows an example method performed by the UE 121, e.g. also referred to as the first UE 121 and the UE 120, 121. The method is e.g. for handling an MDT measurement in the wireless communications network 100. The method may comprise any one or more out of the actions below. The following actions may be performed in any suitable order.

### Action 701

The UE 121 receives an MDT configuration from the RAN node 110. The MDT configuration comprises one or more parameters. The one or more parameters comprises respective one or more filtering criteria related to type of network support and/or UE characteristic and/or level of granularity, to be used by the UE 121 for performing MDT measurements. The MDT configuration configures the UE 121 to measure and report MDT measurements according to said filtering criteria.

The MDT configuration may further configure the UE 121 e.g. to determine or to evaluate to determine, whether and/or when the UE 121 should perform MDT measurements filtered according to the filtering criteria.

In some embodiments, the one or more filtering criteria, related to type of network support and/or UE characteristic and/or level of granularity, relate to any one or more out of:
a High Speed Data Network, HSDN, and/or indications or conditions pertaining to speed,
a value or range of values of UE velocity,
an NR-R or NR-Railway indication,
a UE type or UE category,
Mobility Restrictions,
a Type of Core Network e.g. EPC or 5GC
a Non-Public Network,
a Public Warning System PWS,
an Integrated Access and Backhaul, IAB,
a Slice, e.g. one or a list of S-NSSAIs, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
an Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT,

In some embodiments, the MDT configuration further comprises to apply the MDT measurement and send the MDT measurement report according to any one or more out of:
per MDT mode,
per MDT measurements,
per “Area Scope of MDT” value, and
per “event configuration”.

### Action 702

In some embodiments, the UE 121 evaluates to decide whether and/or when the UE 121 shall perform MDT measurements filtered according to the filtering criteria.

In some embodiments, the UE 121 decides whether and/or when the UE 121 shall perform MDT measurements filtered according to the filtering criteria.

### Action 703

The UE 121 may then perform an MDT measurement. The MDT measurement is measured according to the filtering criteria.

### Action 704

In some embodiments, the UE 121 sends a report to the RAN node 110, reporting the MDT measurement measured according to the filtering criteria. The report may further comprise the filtering criteria used for filtering the reported MDT measurement.

It should be noted that the wordings “UE 120, 121”, “UEs 120, 121” and “group of UEs 102, 121 are used interchangeably herein.

The method will now be further explained and exemplified in below embodiments. These below embodiments may be combined with any suitable embodiment as described above.

### Disclaimers

The terms “UE”, “terminal equipment”, “wireless terminal” and “terminal”, “wireless device” are used interchangeably.

The terms UE RRC configuration, UE RRC context, RRC configuration, RRC context, or just configuration and context are used interchangeably.

In examples of embodiments herein, the RAN node 110 may receive, from another network node (such as a RAN node, a CN node, an OAM node, an SMO node) the set of parameters of an MDT configuration, indicating filtering criteria to use, e.g., in determining whether or not the first UE 121 or a group of UEs 120, 121 is (are) eligible for MDT measurements. The RAN node 110 may send at least part of said set of parameters to the UE 120 in the MDT configuration over the air interface. The RAN node 110 may further receive at least part of said set of parameters from the first UE 121 or group of UEs 120, 121 in MDT reporting.

### Network Embodiments

In some embodiments, a network node, such as a RAN node, a CN node, an OAM node, an SMO node, sends to the RAN node 110 an MDT measurement configuration that is enhanced to consider support (or lack of support) of one or more of the characteristics, also referred to as filter criteria, indicated in the next embodiment.

In one embodiment, the RAN node 110 receives from another network node (such as a RAN node, a CN node, an OAM node, an SMO node) an enhanced MDT measurement configuration that supports and/or is capable of (or does not support and/or is not capable of) one or more of the following characteristics or indications, also referred to as parameters or as filter criteria, related to type of network support and/or UE characteristic and/or level of granularity, may relate to any one or more out of:

### High Speed Data Network, and/or Indications or Conditions Pertaining to Speed

With this characteristic, the scope of MDT measurements may be obtained by considering an inclusive filter (or an exclusive filter) based on one or more or indication(s) and/or configuration parameters pertaining to a High Speed Data Network, UE grouping according to speed, and/or UE velocity related to the UE 120, 121.

In one example, a cell or at least part of a radio network may be included or excluded in the scope of MDT measurements depending on indication of support for HSDN capable UE, such as e.g. the UE 120, 121.

In more specific examples, referred to a cell (or to list of cells), this may be captured in the standard in various ways. In some non-limiting examples indicating: “an HSDN cell”, or “a cell HSDN capable”, or “a cell with HSDN support”, or “a list of HSDN cells”, or “a list of cells HSDN capable”, or “a list of cells with HSDN support”.

Similar more specific examples may be referred to other portions of a radio network, e.g.:
for a Tracking Area (or a list of Tracking Areas), indicating an “HSDN Tracking Area”, or “Tracking Area HSDN capable” or “Tracking Area with HSDN support”, or “a list of HSDN TAS”, or “a list of TAs HSDN capable” or “a list of TAs with HSDN support”)
for a PLMN or a list of PLMN, indicating an “HSDN PLMN”, or “PLMN HSDN capable” or “PLMN with HSDN support” or “a list of HSDN PLMNs”, or “a list of PLMNs HSDN capable” or “a list of PLMNs with HSDN support”
for a geographical area, e.g. delimited by configured polygons, indicating a “HSDN Area” or “an Area HSDN capable” or “Area with HSDN support”

In another example of “High Speed” condition may relate the presence of a configuration parameter indicating a value or range of values of UE velocity of the UE 120, 121.

### LTE-R (or LTE-Railway) Indication

With this indication, the MDT measurement configuration considers LTE customized for Railway network as part of the area scope to configure the UEs such as e.g. the UE 120, 121 to perform the MDT measurements in an LTR-Railway.

### NR-R (or NR-Railway) Indication

With this indication, the MDT measurement configuration considers NR customized for Railway network as part of the area scope to configure the UEs, such as e.g. the UEs 120, 121, to perform the MDT measurements in an LTR-Railway.

### UE Type or UE Category

With this indication, the MDT measurement configuration instructs the RAN node 110 to pick up the UEs, such as e.g. the UEs 120, 121, from specific type or category. A use case for this indication is selecting a correct UE, such as e.g. the UEs 120, 121, or group of UEs 120, 121, in an industrial network e.g., selecting/configuring the first UE 121 from cat-M or URLLC UE instead of other UEs (personals) in the area.

In some embodiments OAM or SMO may indicate to the RAN node 110 to configure any type and/or any category of the UE 120, 121. In some other embodiments, absence of this information indicates that the RAN node 110 may choose UEs such as e.g. the UEs 120, 121 from any UE type and/or UE category.

### Closed Subscribed Group (CSG)

With this characteristic, the scope of MDT measurements may be obtained considering an inclusive filter (or an exclusive filter) based on one or more or indication(s) and/or configuration parameters pertaining to CSG.

### Mobility Restrictions

With this characteristic, the scope of MDT measurements may be obtained considering an inclusive filter (or an exclusive filter) based on one or more or indication(s) and/or configuration parameters pertaining Mobility Restrictions

Some examples may be provided using indications comprised in 3GPP TS 38.413 v16.0.0: a certain RAT is restricted, a TAC is forbidden, a TAC is not-allowed, a connection to a CN type is forbidden.

### Type of Core Network (e.g. EPC or 5GC)

With this characteristic, the scope of MDT measurements is obtained considering an inclusive filter (or an exclusive filter) based on one or more or indication(s) and/or configuration parameters pertaining to a type of CN connectivity

### Non-Public Network

With this characteristic, the scope of MDT measurements may be obtained considering an inclusive filter (or an exclusive filter) based on one or more or indication(s) and/or configuration parameters pertaining to Non-Public Network (such as Public Network Integrated Non-Public Network (PNI-NPN), Stand-alone Non-Public Network (SNPN), Onboarding Network (ONN).

In one example, related to PNI-NPN, inclusion or exclusion in the scope of MDT measurements can be based on the fact that UEs 120, 121 are served by a cell (e.g. an NPN-only cell) that broadcasts one of a certain set of CAG identity/identities, wherein the filter may be inclusive (such that only NPN-only cells broadcasting one of a certain set of specific CAG identity/identities are included) or exclusive (such that NPN-only cells broadcasting one of a certain set of specific CAG identity/identities are excluded).

In another example, related to SNPN, inclusion or exclusion in the scope of MDT measurements can be based on the fact that UEs are served by a cell broadcasting one of a certain set of NID(s), and the filter may be inclusive (such that only NPN-only cells broadcasting one of a certain set of specific NID(s) are included) or exclusive (such that NPN-only cells broadcasting one of a certain set of specific NID(s) are excluded).

### Public Warning System (PWS)

With this characteristic, the scope of MDT measurements may be obtained considering an inclusive filter (or an exclusive filter) based on one or more or indication(s) and/or configuration parameters pertaining to Public Warning System.

### Sidelink

With this characteristic, the scope of MDT measurements may be obtained considering an inclusive filter (or an exclusive filter) based on one or more or indication(s) and/or configuration parameters pertaining to Sidelink (e.g. relevant for V2X scenarios).

### IAB

With this characteristic, the scope of MDT measurements may be obtained considering an inclusive filter (or an exclusive filter) based on one or more or indication(s) and/or configuration parameters pertaining to IAB. Some non-limiting examples are:

A cell's inclusion in the Area Scope is filtered based on whether the cell is served by an IAB node (e.g. a gNB being connected to another gNB via IAB (i.e. via the Uu interface)), wherein the filter may be inclusive (such that only cells served by IAB nodes are included) or exclusive (such that cells served by IAB nodes are excluded).

An IAB Cell is included in/excluded from the Area Scope if it is served by an IAB node that is located a certain number of hops from the IAB donor (e.g. measurements are taken only in cells served by IAB nodes located 3 or more hops from the IAB donor).

An IAB Cell is included in/excluded from the Area Scope if it is served by an IAB node that is located, in the IAB topology, upstream or downstream from a certain IAB node (this “certain” IAB node is e.g. an IAB node that is a bottleneck).

An IAB Cell is included in/excluded from the Area Scope if it is served by an IAB node that is single-or multiconnected with the donor (using NR-DC or EN-DC).

An IAB cell is included in/excluded from the Area Scope if the traffic for the UEs served by this cell is carried:
Over certain IAB paths and/or via certain IAB node(s) (serving as the access node or as an intermediate node on the route between the IAB donor and the UEs 120, 121 served by the IAB cell) and/or via certain backhaul links.
Over 1:1- or N:1-mapped BH RLC channels.

### Slice, e.g. One or a List of S-NSSAIs, or a Part of an S-NSSAI, such as a Slice/Service Type (SST), or a Slice Differentiator (SD)

With this characteristic, the scope of MDT measurements may be obtained considering an inclusive filter (or an exclusive filter) based on one or more or indication(s) and/or configuration parameters pertaining to slice. Some non-limiting examples are:

MDT measurements are configured only to UEs 120, 121 using a certain S-NSSAI, or a certain list of S-NSSAIs.

A cell's inclusion in the Area Scope is filtered based on whether the cell supports at least one of a certain set of network slice(s), wherein the filter may be inclusive (such that only cells supporting at least one of a certain set of specific slices (e.g. S-NSSAIs/SSTs/SDs) are included or exclusive (such that cells supporting at least one of a certain set of specific slices (e.g. S-NSSAIs/SSTs/SDs) are excluded. As an alternative, the criterion may logically classify a cell as being part of the Area Scope or not being part of the Area Scope based on slice attributes (e.g. S-NSSAIs/SSTs/SDs) the UE is using. For the UE 120, 121, when configured for MDT data collection according to this Area Scope, that is using network slice X or Y (e.g. SST=X or SST=Y) in the cell, the cell is considered to be part of the Area Scope and the UE consequently collects MDT measurements in the cell, while for the UE 120, 121 when configured for MDT measurements collection according to this Area Scope, that is using another network slice (neither X nor Y) in the same cell, the cell is not considered part of the Area Scope and consequently the UE 120, 121 does not collect MDT measurements in the cell.

### Radio Bearer or Radio Bearer Type

With this characteristic, the scope of MDT measurements is obtained considering an inclusive filter (or an exclusive filter) based on one or more or indication(s) and/or configuration parameters pertaining to signaling radio bearer and/or data radio bearer used in a radio connection (e.g. SRB Id, DRB Id, Split bearer, DAPS bearer, MN/SN terminated MCG/SCG bearer).

### Cell Type Attribute

With this characteristic, the scope of MDT measurements may be obtained considering an inclusive filter (or an exclusive filter) based on whether a cell is a Primary Cell, a Primary SCG Cell, a Secondary Cell, a Serving Cell, a Special Cell, a PUCCH SCell, a PUSCH-Less SCell

### Connectivity Mode

With this characteristic, the scope of MDT measurements is obtained considering an inclusive filter (or an exclusive filter) based on a certain type of connectivity (e.g. single connectivity, dual connectivity, multi-radio dual connectivity, carrier aggregation, EN-DC, NR-DC, NGEN-DC, NE-DC)

### Duplex Mode

With this characteristic, the scope of MDT measurements is obtained considering an inclusive filter (or an exclusive filter) based on a whether a certain type of duplex mode is used (e.g. TDD or FDD).

### RAT

With this characteristic, the scope of MDT measurements may be obtained considering an inclusive filter (or an exclusive filter) based on RAT:

For examples: only include NR, or only include E-UTRA, or exclude E-UTRA

### Multicast and/or Broadcast (e.g. MBMS)

With this characteristic, the scope of MDT measurements may be obtained considering an inclusive filter (or an exclusive filter) based on one or more or indication(s) and/or configuration parameters pertaining to Multicast service and/or Broadcast service.

For example, a cell's inclusion in the Area Scope is filtered based on whether the cell supports MBMS, wherein the filter may be inclusive (such that only cells supporting MBMS are included) or exclusive (such that cells supporting MBMS are excluded)

### NB-IoT

With this characteristic, an MDT configuration may consider a filter (inclusive or exclusive) based on whether NB-IoT is supported.

### Operation in Unlicensed Spectrum (e.g. NR-U)

With this characteristic, the scope of MDT measurements may be obtained considering an inclusive filter (or an exclusive filter) based on one or more or indication(s) and/or configuration parameters pertaining to NR-U (e.g. if NR-U is used and/or configured).

### Non-Terrestrial Network (NTN)

With this characteristic, the scope of MDT measurements may be obtained considering an inclusive filter (or an exclusive filter) based on one or more or indication(s) and/or configuration parameters pertaining to NTN (e.g. if NTN is provided in a cell or a portion of a network (e.g. a TA), wherein the filter may be inclusive or exclusive. This characteristic may be refined and divided into different classes of NTNs, such as GEO NTNs, MEO NTNs, LEO NTNs, HAPS NTNs and HIBS NTNs. For instance, the filter criterion may be that a cell is included in the Area Scope if it is a LEO NTN cell or that the cell is excluded from the Area Scope if it is a LEO NTN cell. The filter criterion may also comprise a set of NTN types. For instance, the filter criterion may be that a cell is included in the Area Scope if it is a GEO NTN cell or a MEO NTN cell, or that the cell is excluded from the Area Scope if it is a GEO NTN cell or a MEO NTN cell.

### Geographical Area Definition

With this characteristic, the scope of MDT measurements may be obtained considering a filter on geographical area defined using geographical parameters and/or geometrical shape (e.g. polygons or ellipses) parameters, instead of, or as a complement to, cells and areas consisting of cells. Parameters for such area definitions are already specified in various standard specifications (e.g. 3GPP TS 36.331 v 16.6.0 (e.g. in the LocationInfo IE), 3GPP TS 23.041 v 17.2.0 and ATIS 0700041: “WEA 3.0: Device-Based Geo-Fencing”) and can be reused.

### RRC State

With this characteristic, the scope of MDT measurements may be obtained considering a filter based on RRC state of the UE 120, 121 (e.g. only consider NR RRC_INACTIVE, or exclude NR RRC_INACTIVE)

### Transition(s) Among RRC States

With this characteristic, the scope of MDT measurements may be obtained considering a filter based on transition(s) of the UE 120, 121 from a first RRC state to a second RRC state (e.g. MDT measurements starts at transition from NR RRC_INACTIVE to NR RRC_CONNECTED, or after a certain number of transitions from NR RRC_INACTIVE to NR_RRC_CONNECTED). Transitions between RRC states can also be used to indicate start and stop conditions for MDT measurements. For example, it may be indicated to the UE 120, 121 to start MDT measurements at transition between a first set of RRC states and then stops MDT measurements at a later transition between a second set of RRC states. As an example, this criterion can be used to indicate the start of MDT measurements at a transition (or a mutliplicity of transitions) from NR RRC_CONNECTED to NR RRC_INACTIVE and the stop of MDT measurements at later transition(s) from NR RRC_CONNECTED to NR-RRC_IDLE).

### Resource Coordination and Interference Mitigation in the Cells

With this characteristic, the scope of MDT measurements may be obtained considering an inclusive filter (or an exclusive filter) based on one or more or indication(s) and/or configuration parameters pertaining to mechanism(s) for resource coordination and interference mitigation mechanism are activated/supported in a cell (i.e. at the RAN node 110 serving the cell). The said mechanisms may include and are not limited to cross-link interference management, remote interference management, cell-level resource coordination (e.g. spectrum sharing), UE-level resource coordination, as defined in 3GPP TS 38.300 v16.7.0, TS 38.401 v16.7.0, TS 38.473 v16.7.0, TS 38.423 v16.7.0, TS 36.423 v16.7.0 and TS 38.413 v16.7.0.

### Area Scope Definitions (e.g. Cell Based, TA Based, TAI Based) Including Logical Expressions

With this characteristic, the scope of MDT measurements is obtained considering an inclusive filter (or an exclusive filter) based on Area Scope definitions that include logical expressions, such as Boolean algebraic expressions, e.g. AND/OR/XOR/NOT logic. For instance: A cell belongs to the Area Scope if it belongs to Tracking Area List {TA X, TA Y, TA Z}.AND. (the cell supports slice SST=Q.OR. the cell supports NB-IoT). In this example, QoE data collection is activated (or kept active) only when the UE is located in a cell belonging to either of the tracking areas X, Y or Z AND the cell also either supports the network slice with SST=Q OR supports NB-IoT (or both).

### Combinations of Existing Area Scope Definition Means/Possibilities

With this characteristic, the Area scope of MDT measurements may be obtained considering a combination of:
a list of tracking areas,
a list of cells,
a list of Location Areas,
a list of Routing Areas.

### Configurations or Usage of Network Features Others than MDT, Type of Network Resources, Other Radio Related Measurements, Applications Layer Measurements.

Non-limiting examples may be:
Conventional QoE (i.e. QoE measurements non interpretable by RAN) is configured or is ongoing (e.g. in a PLMN, in a Tracking Area, in a cell, for a S-NSSAI), in general, or for specific service type(s), or service subtype(s), or application(s)
RAN Visible QoE (i.e. QoE measurements interpretable by RAN) is configured or ongoing (e.g. in a PLMN, in a Tracking Area, in a cell, for a S-NSSAI), in general or for specific service type(s), or service subtype(s), or application(s)
Alignment between MDT and conventional QoE
Alignment between MDT and RAN visible QoE
Power saving enhancements
Network sharing
2-step RACH support

An MDT configuration may be further extended so one or more filtering criteria previously defined can apply:

### Per MDT Mode

One or more of the previously defined filtering criteria may be applicable to a specific value of MDT Activation (e.g. only in case of “Immediate MDT only” or “Logged MDT only”). For example, a HSDN support criterion is enabled for Logged MDT (and not for Immediate MDT, or vice versa), or one or a list of S-NSSAIs is used as further filtering criteria only in case of Immediate MDT (or in case of Logged MDT)

### Per MDT Measurements

One or more of the previously defined filtering criteria may be applicable to a specific MDT measurement (e.g. applicable to “M1 Configuration”, or applicable to “M4 Configuration”, or applicable to “M6 Configuration”, or applicable to “M1 Configuration and M4 Configuration”), or in alternative based on an exclusive filter per MDT measurement (e.g. not applicable to “M1 Configuration”).

### Per “Area Scope of MDT” Value

One or more of the previously defined filtering criteria may be applicable to one or more of the choices of the Area Scope, e.g. a filtering criterion on HSDN or on Non-Private Network only applies to “Cell based” or only to “TA based”.

### Per “Event Configuration”

One or more of the previously defined filtering criteria may be configured in terms of event configurations. An event configuration may indicate whether MDT measurements can start, stop, pause, resume.

In one example, an event configuration could indicate one or more HSDN cell(s) as the serving cell(s), or one or more HSDN cell(s) as cell(s) comprised in a mobility event, or one or more HSDN cell(s) as cell(s) comprised in multi-connectivity operation (e.g. a cell is used for Carrier Aggregation as PCell, or as SPCell, or a PSCell, or is used in one of the forms of MR-DC, or as one of the cells of MN/SN terminated MCG bearer or as one of the cells of MN/SN terminated SCG bearer, or as one of the cells in a Split MCG bearer, or as one of the cells in a Split SCG bearer). The event configuration can be used in a way that, upon receiving such a configuration the UE 120, 121 performs logging of measurements only when the UE is being served by a HSDN cell, or upon mobility to/from a HSDN cell, or when a HSDN cell is comprised in a multi-connectivity operation.

In another example, an event configuration could indicate to the UE to perform logging of measurements only when the UE is also collecting conventional QoE measurements, or the UE is also collecting RAN Visible QoE measurements, or both conventional and RAN Visible QoE measurements

In another example, an event configuration may indicate to the UE 102, 121 to start or to stop logging of measurements according to one of the filtering criteria listed in the other embodiments and continue until further notice, or for a given amount of time (or equivalently an amount of samples)

In another example, an event configuration may indicate to the UE 102, 121 to stop logging of measurements, immediately, or according to one of the filtering criteria listed in the other embodiments.

In another example, an event configuration may indicate to the UE(s) 102, 121 to start logging measurements according to at least one of the filtering criteria listed in the other embodiments and/or indicate to the UE to stop logging measurements according to at least one of the filtering criteria listed in the other embodiments.

In another example, an event configuration may indicate to UE(s) 102, 121 to start (or to stop, or to pause or to resume) logging measurements upon one of: start of a timer, stop of a timer, expiration of a timer, reset of a timer. As an example, an event configuration can indicate to UE(s) 102, 121 to start logging measurements upon start/stop/expiry of one of the timers described in 3GPP TS 38.331 v16.6.0 (e.g. T300, T301, T304, T310, T311, T319)

In another example, an event configuration could indicate to UE(s) to start (or to stop, or to pause, or to resume) logging measurements upon start (or completion, or failure) of a mobility procedure or a multi-radio connectivity procedure as described in 3GPP TS 37.340 v16.7.0 (e.g. Secondary Node Addition, Secondary Node Modification, Secondary Node Release, Secondary Node Change, Inter-Master Node handover with/without Secondary Node change, Master Node to eNB/gNB Change, eNB/gNB to Master Node change)

### To a Bluetooth Measurement Configuration

### To a WLAN Measurement Configuration

### To a Sensor Measurement Configuration

In some embodiment, a RAN node 110 sends to the UE 121 or to a group of UEs 120, 121 indications and/or configuration parameters used for enhancement of an MDT configuration.

In one embodiment, a RAN node 110 receives from the UE or the group of UEs 120, 121 MDT reports obtained according to an enhanced MDT configuration as determined in the previous embodiments.

### UE Embodiments

In one embodiment, a UE 121 or a group of UEs 120, 121 performs one or more out the following:

Receiving from the RAN node 110 an MDT configuration comprising filter criterion/criteria for the UE to evaluate to determine whether and when UE(s) 120, 121 should activate MDT measurements.

Evaluating the filter criterion/criteria for the UE(s) 120, 121.

Determining, based on the result of the evaluation, whether the UE(s) 120, 121 should activate (or continue to perform) requested MDT measurements.

Activating or continue to perform MDT measurements if the determination is that the UE 120, 121 should activate or continue to perform MDT measurement.

In some another embodiments, the UE 121 or a group of UEs 120, 121 reports to a RAN node 110 MDT measurements, collected, wherein the MDT reports can comprise at least part of the indications and/or configuration parameters comprised in the MDT configuration received by a RAN node 110.

### Examples of Implementation—NGAP

An example of implementation is shown in the table below based on 3GPP TS 38.413 v16.6.0. Underlined text of below table relates to additions made according to embodiments herein.

### 9.3.1.169 MDT Configuration—NR

This IE defines the MDT configuration parameters of NR.

| | | | IE type and | Semantics |
|---|---|---|---|---|
| IE/Group Name | Presence | Range | reference | description |
| MDT Activation | M | | ENUMERATED | |
| | | | (Immediate MDT | |
| | | | only, Logged MDT | |
| | | | only, Immediate | |
| | | | MDT and Trace, . . . ) | |
| CHOICE Area Scope of MDT | M | | | |
| >Cell based | | | | |
| >>Cell ID List for MDT | | 1 . . . | | |
| | | <maxnoofCellIDforMDT> | | |
| >>>NR CGI | M | | 9.3.1.7 | |
| >> HSDN Support | O | | ENUMERATED | Indicates that MDT |
| | | | (true) | measurements are to |
| | | | | be collected for the |
| | | | | cell only in case of |
| | | | | HSDN support. |
| | | | | (Note: this applies only |
| | | | | if “Area Scope of |
| | | | | MDT” value is “Cell |
| | | | | based”) |
| >> NPN Support | O | | ENUMERATED | Indicates that MDT |
| | | | (true) | measurements are to |
| | | | | be collected for the |
| | | | | cell only in case of |
| | | | | NPN support. |
| | | | | (Note: this applies only |
| | | | | if “Area Scope of |
| | | | | MDT” value is “Cell |
| | | | | based”) |
| >TA based | | | | |
| >>TA List for MDT | | 1 . . . | | |
| | | <maxnoofTAforMDT> | | |
| >>>TAC | M | | 9.3.3.10 | The TAI is derived |
| | | | | using the current |
| | | | | serving PLMN. |
| >PLMN wide | | | NULL | |
| >TAI based | | | | |
| >>TAI List for MDT | | 1 . . . | | |
| | | <maxnoofTAforMDT> | | |
| >>>TAI | M | | | |
| CHOICE MDT Mode | M | | | |
| >immediate MDT | | | | |
| >>Measurements to | M | | BITSTRING | Each position in the |
| Activate | | | (SIZE(8)) | bitmap indicates a |
| | | | | MDT measurement, as |
| | | | | defined in TS 37.320 |
| | | | | [41]. |
| | | | | First Bit = M1, |
| | | | | Second Bit = M2, |
| | | | | Third Bit = M4, |
| | | | | Fourth Bit = M5, |
| | | | | Fifth Bit = M6, |
| | | | | Sixth Bit = M7, |
| | | | | Seventh Bit = logging |
| | | | | of M1 from event |
| | | | | triggered |
| | | | | measurement reports |
| | | | | according to existing |
| | | | | RRM configuration, |
| | | | | other bits reserved for |
| | | | | future use. |
| | | | | Value “1” indicates |
| | | | | “activate” and value |
| | | | | “0” indicates “do not |
| | | | | activate”. |
| >>M1 Configuration | C-ifM1 | | 9.3.1.171 | |
| >>M4 Configuration | C-ifM4 | | 9.3.1.172 | |
| >>M5 Configuration | C-ifM6 | | 9.3.1.173 | |
| >>M6 Configuration | C-ifM6 | | 9.3.1.174 | |
| >>M7 Configuration | C-ifM7 | | 9.3.1.175 | |
| >>Bluetooth Measurement | O | | 9.3.1.177 | |
| Configuration | | | | |
| >>WLAN Measurement | O | | 9.3.1.178 | |
| Configuration | | | | |
| >>MDT Location | O | | 9.3.1.176 | |
| Information | | | | |
| >>Sensor Measurement | O | | 9.3.1.179 | |
| Configuration | | | | |
| >>HSDN Support | O | | ENUMERATED | Indicates If MDT |
| | | | (true) | measurements are to |
| | | | | be collected only in |
| | | | | case of HSDN support |
| | | | | within the Area Scope |
| | | | | of MDT |
| | | | | (Note: this applies only |
| | | | | if “MDT Mode” value is |
| | | | | “Immediate MDT”) |
| >> NPN Support | O | | ENUMERATED | Indicates If MDT |
| | | | (true) | measurements are to |
| | | | | be collected only in |
| | | | | case of NPN support |
| | | | | within the Area Scope |
| | | | | of MDI. |
| | | | | (Note: this applies only |
| | | | | if “MDT Mode” value is |
| | | | | “Immediate MDT”) |
| >> Slice Support | O | | ENUMERATED | Indicates if MDT |
| | | | (true) | measurements are to |
| | | | | be collected only for |
| | | | | the S-NSSAIs included |
| | | | | in the S-NSSAI |
| | | | | Support List. |
| | | | | (Note: this applies only |
| | | | | if “MDT Mode” value is |
| | | | | “Immediate MDT”) |
| >>> S-NSSAI | M | 1 . . . | | (Note: this applies |
| Support List | | <maxnoofSliceItems> | | to “MDT Mode” value |
| | | | | “Immediate MDT”) |
| >>>> S-NSSAI Support | M | | 9.3.1.24 | (Note: this applies only |
| Item | | | | if “MDT Mode” value is |
| | | | | “Immediate MDT”) |
| >Logged MDT | | | | |
| >>Logging interval | M | | ENUMERATED | This IE is defined in |
| | | | (320 ms, 640 ms, | TS 38.331 [18]. |
| | | | 1280 ms, 2560 ms, | |
| | | | 5120 ms, 10240 ms, | |
| | | | 20480 ms, 30720 ms, | |
| | | | 40960 ms, 61440 ms, | |
| | | | infinity, . . . ) | |
| >>Logging duration | M | | ENUMERATED | This IE is defined in |
| | | | (10, 20, 40, 60, | TS 38.331 [18]. Unit: |
| | | | 90, 120, . . . ) | [minute]. |
| >>CHOICE Report Type | M | | | |
| >>>Periodical | | | NULL | |
| >>>Event Triggered | | | | |
| >>>>Event Trigger | M | | 9.3.1.180 | |
| Logged MDT | | | | |
| Configuration | | | | |
| >>Bluetooth Measurement | O | | 9.3.1.177 | |
| Configuration | | | | |
| >>WLAN Measurement | O | | 9.3.1.178 | |
| Configuration | | | | |
| >>Sensor Measurement | O | | 9.3.1.179 | |
| Configuration | | | | |
| >>Area Scope of | O | | 9.3.1.182 | |
| Neighbour Cells | | | | |
| >>HSDN Support | O | | ENUMERATED | Indicates if MDT |
| | | | (true) | measurements are to |
| | | | | be collected only in |
| | | | | case of HSDN support |
| | | | | within the Area Scope |
| | | | | of MDT. |
| | | | | (Note: this applies only |
| | | | | if “MDT Mode” value is |
| | | | | “Logged MDT”) |
| >> NPN Support | O | | ENUMERATED | Indicates if MDT |
| | | | (true) | measurements are to |
| | | | | be collected only in |
| | | | | case of NPN support |
| | | | | within the Area Scope |
| | | | | of MDT. |
| | | | | (Note: this applies only |
| | | | | if “MDT Mode” value is |
| | | | | “Logged MDT”) |
| >> Slice Support | O | | ENUMERATED | Indicates If MDT |
| | | | (true) | measurements are to |
| | | | | be collected only for |
| | | | | the S-NSSAIs included |
| | | | | in the S-NSSAI |
| | | | | Support List. |
| | | | | (Note: this applies only |
| | | | | if “MDT Mode” value is |
| | | | | “Logged MDT”) |
| >>> S-NSSAI | M | 1 . . . | | (Note: this applies only |
| Support List | | <maxnoofSliceItems> | | if “MDT Mode” value is |
| | | | | “Logged MDT”) |
| >>>> S-NSSAI | M | | 9.3.1.24 | (Note: this applies only |
| Support Item | | | | if “MDT Mode” value is |
| | | | | “Logged MDT”) |
| Signalling Based | O | | MDT PLMN List | |
| MDT PLMN | | | 9.3.1.168 | |
| List | | | | |
| HSDN Support | O | | ENUMERATED | Indicates if MDT |
| | | | (true) | measurements are to |
| | | | | be collected only in |
| | | | | case of HSDN support |
| | | | | within the Area Scope |
| | | | | of MDT. |
| | | | | (Note: this applies to |
| | | | | all values of “Area |
| | | | | Scope of MDT”, and to |
| | | | | all values of “MDT |
| | | | | Mode”) |
| NPN Support | O | | ENUMERATED | Indicates If MDT |
| | | | (true) | measurements are to |
| | | | | be collected only in |
| | | | | case of NPN support |
| | | | | within the Area Scope |
| | | | | of MDT. |
| | | | | (Note: this applies to |
| | | | | all values of “Area |
| | | | | Scope of MDT”, and to |
| | | | | all values of “MDT |
| | | | | Mode”) |
| Slice Support | O | | ENUMERATED | Indicates If MDT |
| | | | (true) | measurements are to |
| | | | | be collected only for |
| | | | | the S-NSSAIs Included |
| | | | | in the S-NSSAI |
| | | | | Support List. |
| | | | | (Note: this applies to |
| | | | | all values of “Area |
| | | | | Scope of MDT”, and to |
| | | | | all values of “MDT |
| | | | | Mode”) |
| > S-NSSAI | M | 1 . . . | | (Note: this applies to |
| Support List | | <maxnoofSliceItems> | | all values of “Area |
| | | | | Scope of MDT”, and to |
| | | | | all values of “MDT |
| | | | | Mode”) |
| >> S-NSSAI | M | | 9.3.1.24 | (Note: this applies to |
| Support Item | | | | all values of “Area |
| | | | | Scope of MDT”, and to |
| | | | | all values of “MDT |
| | | | | Mode”) |

| Range bound | Explanation |
|---|---|
| maxnoofCellIDforMDT | Maximum no. of Cell ID subject |
| | for MDT scope. Value is 32. |
| maxnoofTAforMDT | Maximum no. of TA subject for |
| | MDT scope. Value is 8. |

| Condition | Explanation |
|---|---|
| C-ifM1 | This IE shall be present if the Measurements |
| | to Activate IE has the first bit set to “1”. |
| C-ifM4 | This IE shall be present if the Measurements |
| | to Activate IE has the third bit set to “1”. |
| C-ifM5 | This IE shall be present if the Measurements |
| | to Activate IE has the fourth bit set to “1”. |
| C-ifM6 | This IE shall be present if the Measurements |
| | to Activate IE has the fifth bit set to “1”. |
| C-ifM7 | This IE shall be present if the Measurements |
| | to Activate IE has the sixth bit set to “1”. |

### Examples of Implementation—RRC

An example of implementation is shown in the text below for 3GPP TS 38.331. Underline text of below relates to additions made by embodiments herein.

### LoggedMeasurementConfiguration

The LoggedMeasurementConfiguration message is used to perform logging of measurement results while in RRC_IDLE or RRC_INACTIVE. It is used to transfer the logged measurement configuration for network performance optimisation.
Signalling radio bearer: SRB1
RLC-SAP: AM
Logical channel: DCCH
Direction: Network to UE

...
LoggedMeasurementConfiguration-r17-IEs ::= SEQUENCE {

| high-Speed-Data-Network-r17 | ENUMERATED {true} | OPTIONAL, --Need R |
|---|---|---|
| s-NSSAI-List SEQUENCE (SIZE(1..maxNrofS-NSSAI)) OF S-NSSAI | | OPTIONAL, --Need R |
| iab-Support | ENUMERATED {true} | OPTIONAL, --Need R |
| npn-IdentityInfoList-r16 | NPN-IdentityInfoList-r16 | OPTIONAL, --Need R |
| lateNonCriticalExtension | OCTET STRING | OPTIONAL, |
| nonCriticalExtension | SEQUENCE { } | OPTIONAL |

}

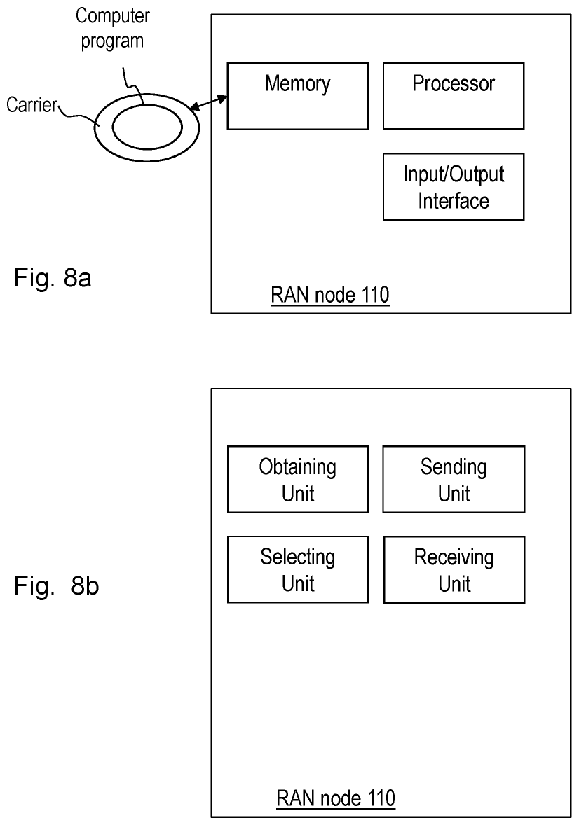

FIGS. 8a and 8b show examples of an arrangement in the RAN node 110.

The RAN node 110 may comprise an input and output interface configured to communicate e.g. with any of the networking entities operating in the wireless communications network 100 of embodiments herein, such as e.g. the UE 121 and/or any one or more out of the UEs 120. The input and output interface may comprise a receiver, e.g. wired and/or wireless, (not shown) and a transmitter, e.g. wired and/or wireless, (not shown).

The RAN node 110 may comprise any one or more out of: a obtaining unit, a sending unit, a selecting unit, and a receiving unit to perform the method actions as described herein, e.g. actions 601-604 above.

The embodiments herein may be implemented through a respective processor or one or more processors, such as at least one processor of a processing circuitry in the RAN node 110 depicted in FIG. 8a, together with computer program code for performing the functions and actions of the embodiments herein. The program code mentioned above may also be provided as a computer program product, for instance in the form of a data carrier carrying computer program code for performing the embodiments herein when being loaded into the RAN node 110. One such carrier may be in the form of a CD ROM disc. It is however feasible with other data carriers such as a memory stick. The computer program code may furthermore be provided as pure program code on a server and downloaded to the RAN node 110.

The RAN node 110 may further comprise a memory comprising one or more memory units. The memory comprises instructions executable by the processor in the RAN node 110. The memory is arranged to be used to store instructions, data, configurations, and applications to perform the methods herein when being executed in the RAN node 110.

In some embodiments, a computer program comprises instructions, which when executed by the at least one processor, cause the at least one processor of the RAN node 110 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules or units in the RAN node 110, described below may refer to a combination of analog and digital circuits, and/or one or more processors configured with software and/or firmware, e.g. stored in the RAN node 110, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

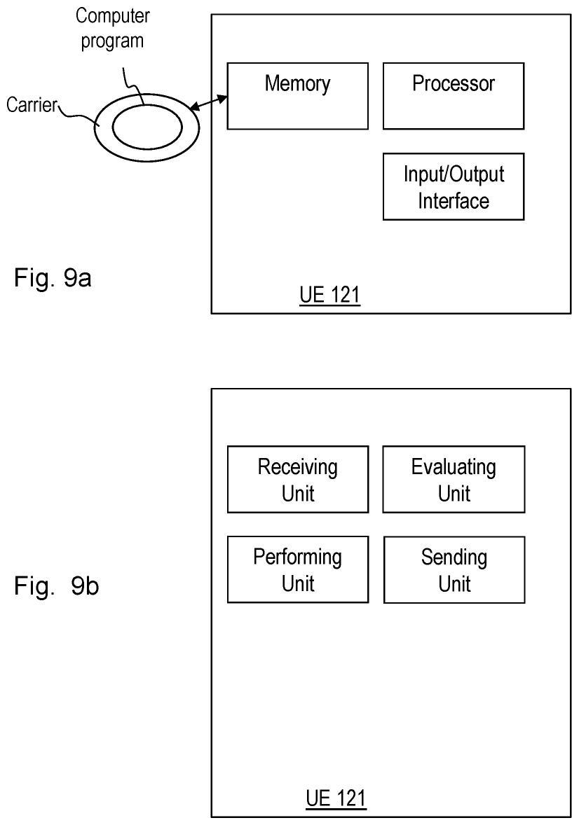

FIGS. 9a and 9b show examples of an arrangement in the UE 121.

The UE 121 may comprise an input and output interface configured to communicate e.g. with any of the networking entities operating in the wireless communications network 100 of embodiments herein, such as e.g. the RAN node 110. The input and output interface may comprise a receiver, e.g. wired and/or wireless, (not shown) and a transmitter, e.g. wired and/or wireless, (not shown).

The UE 121 may comprise any one or more out of: a receiving unit, an evaluating unit, a performing unit, and a sending unit to perform the method actions as described herein, e.g. actions 701-704 above.

The embodiments herein may be implemented through a respective processor or one or more processors, such as at least one processor of a processing circuitry in the UE 121 depicted in FIG. 9a, together with computer program code for performing the functions and actions of the embodiments herein. The program code mentioned above may also be provided as a computer program product, for instance in the form of a data carrier carrying computer program code for performing the embodiments herein when being loaded into the UE 121. One such carrier may be in the form of a CD ROM disc. It is however feasible with other data carriers such as a memory stick. The computer program code may furthermore be provided as pure program code on a server and downloaded to the UE 121.

The UE 121 may further comprise a memory comprising one or more memory units. The memory comprises instructions executable by the processor in the UE 121. The memory is arranged to be used to store instructions, data, configurations, and applications to perform the methods herein when being executed in the UE 121.

In some embodiments, a computer program comprises instructions, which when executed by the at least one processor, cause the at least one processor of the UE 121 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 121, described below may refer to a combination of analog and digital circuits, and/or one or more processors configured with software and/or firmware, e.g. stored in the UE 121, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein are not limited to the preferred embodiments described above. Various alternatives, modifications and equivalents may be used.

Below, some example embodiments 1-32 are shortly described. See e.g. FIGS. 6, 7, 8a, 8b, 9a, and 9b.

### EMBODIMENTS

Embodiment 1. A method performed by a Radio Access Node, RAN, node 110 for e.g. controlling a Minimization of Drive Tests, MDT, measurement to be performed by a User Equipment, UE, 120, 121 or a group of UEs 120, 121 in a wireless communications network 100, the method e.g. comprising any one or more out of:
obtaining 601, e.g. from a network node 130, a set of parameters of an MDT configuration, which set of parameters comprises respective one or more filtering criteria related to type of network support and/or UE characteristic and/or level of granularity, to be used by UEs 120, 121 for performing MDT measurements,
sending 603 to a first UE 121 or a group of UEs 120, 121 comprising the first UE 121, an MDT configuration comprising, one or more parameters, which one or more parameters comprises at least a part of the parameters comprised in the set of parameters, which MDT configuration configures the first UE 121, or the group of UEs 120, 121, to measure and report MDT measurements according to said filtering criteria.

Embodiment 2. The method according to Embodiment 1, further comprising:
based on the obtained set of parameters, selecting 602 the first UE 121, or the group of UEs 120, 121, that is capable of measuring and reporting MDT according to the filtering criteria.

Embodiment 3. The method according to any of the Embodiments 1-2, wherein the MDT configuration further configures the first UE 121, or the group of UEs 120, 121, e.g. to evaluate, to determine whether and/or when the first UE 121, or the group of UEs 120, 121, should perform MDT measurements filtered according to the filtering criteria.

Embodiment 4. The method according to any of the Embodiments 1-3, wherein the one or more filtering criteria, related to type of network support and/or UE characteristic and/or level of granularity, relate to any one or more out of:
a High Speed Data Network, HSDN, and/or indications or conditions pertaining to speed,
an NR-R or NR-Railway indication,
a UE type or UE category,
a Closed Subscribed Group CSG,
Mobility Restrictions,
a Type of Core Network e.g. EPC or 5GC
a Non-Public Network,
a Public Warning System PWS,
an Integrated Access and Backhaul, IAB,
a Slice, e.g. one or a list of S-NSSAIs, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
an Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT,

Embodiment 5. The method according to any of the Embodiments 1-4, wherein the MDT configuration further comprises to apply the MDT measurement and send the MDT measurement report according to any one or more out of:
per MDT mode,
per MDT measurements,
per “Area Scope of MDT” value, and
per “event configuration”

Embodiment 6. The method according to any of the Embodiments 1-5, further comprising:
receiving 604 a report from the first UE 121, or the group of UEs 120, 121, reporting an MDT measurement measured according to the filtering criteria sent to the first UE 121, or the group of UEs 120, 121.

Embodiment 7. The method according to Embodiment 6, wherein the report further comprises the filtering criteria used for filtering the reported MDT measurement.

Embodiment 8. A computer program comprising instructions, which when executed by a processor, causes the processor to perform actions according to any of the Embodiments 1-7.

Embodiment 9. A carrier comprising the computer program of Embodiment 8, wherein the carrier is one of an electronic signal, an optical signal, an electromagnetic signal, a magnetic signal, an electric signal, a radio signal, a microwave signal, or a computer-readable storage medium.

Embodiment 10. A method performed by a User Equipment, UE, 121, e.g. also referred to as the first UE 121, e.g. for handling a Minimization of Drive Tests MDT measurement in a wireless communications network 100, the method e.g. comprising any one or more out of:
receiving 701 an MDT configuration from a Radio Access Node, RAN, node 110, the MDT configuration comprising one or more parameters comprising respective one or more filtering criteria related to type of network support and/or UE characteristic and/or level of granularity, to be used by the UE 121 for performing MDT measurements, which MDT configuration configures the UE 121 to measure and report MDT measurements according to said filtering criteria.

Embodiment 11. The method according to Embodiment 10, wherein the MDT configuration further configures the UE 121 e.g. to evaluate, to determine whether and/or when the UE 121 should perform MDT measurements filtered according to the filtering criteria.

Embodiment 12. The method according to any of the Embodiments 10-11, further comprising:
evaluating 702 to decide whether and/or when the UE 121 shall perform MDT measurements filtered according to the filtering criteria.

Embodiment 13. The method according to any of the Embodiments 10-12, further comprising:
performing 703 an MDT measurement measured according to the filtering criteria, and
sending 704 a report to the RAN, node 110, reporting the MDT measurement measured according to the filtering criteria.

Embodiment 14. The method according to Embodiment 13, wherein the report further comprises the filtering criteria used for filtering the reported MDT measurement.

Embodiment 15. The method according to any of the Embodiments 10-14, wherein the one or more filtering criteria, related to type of network support and/or UE characteristic and/or level of granularity, relate to any one or more out of:
a High Speed Data Network, HSDN, and/or indications or conditions pertaining to speed,
an NR-R or NR-Railway indication,
a UE type or UE category,
a Closed Subscribed Group CSG,
Mobility Restrictions,
a Type of Core Network e.g. EPC or 5GC
a Non-Public Network,
a Public Warning System PWS,
an Integrated Access and Backhaul, IAB,
a Slice, e.g. one or a list of S-NSSAls, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
an Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT,

Embodiment 16. The method according to any of the Embodiments 10-15, wherein the MDT configuration further comprises to apply the MDT measurement and send the MDT measurement report according to any one or more out of:
per MDT mode,
per MDT measurements,
per “Area Scope of MDT” value, and
per “event configuration”

Embodiment 17. A computer program comprising instructions, which when executed by a processor, causes the processor to perform actions according to any of the Embodiments 10-16.

Embodiment 18. A carrier comprising the computer program of Embodiment 17, wherein the carrier is one of an electronic signal, an optical signal, an electromagnetic signal, a magnetic signal, an electric signal, a radio signal, a microwave signal, or a computer-readable storage medium.

Embodiment 19. A Radio Access Node, RAN, node 110 configured to e.g. control a Minimization of Drive Tests MDT measurement to be performed by a User Equipment, UE, 120, 121 or a group of UEs 120, 121 in a wireless communications network 100, the RAN node 110 e.g. being further configured to any one or more out of:
obtain, e.g. from a network node 130, e.g. by means of an obtaining unit in the RAN node 110, a set of parameters of an MDT configuration, which set of parameters is adapted to comprise respective one or more filtering criteria related to type of network support and/or UE characteristic and/or level of granularity, to be used by UEs 120, 121 for performing MDT measurements,
send, e.g. by means of a sending unit in the RAN node 110, an MDT configuration to a first UE 121 or a group of UEs 120, 121 comprising the first UE 121, which MDT configuration comprises one or more parameters, which one or more parameters are adapted to comprise at least a part of the parameters comprised in the set of parameters, which MDT configuration is adapted to configure the first UE 121, or the group of UEs 120, 121, to measure and report MDT measurements according to said filtering criteria.

Embodiment 20. The RAN node 110 according to Embodiment 19, further configured to:
e.g. by means of a selecting unit in the RAN node 110, based on the obtained set of parameters, select the first UE 121, or the group of UEs 120, 121, that is capable of measuring and reporting MDT according to the filtering criteria.

Embodiment 21. The RAN node 110 according to any of the Embodiments 19-20, wherein the MDT configuration is adapted to further configure the first UE 121, or the group of UEs 120, 121, e.g. to evaluate, to determine whether and/or when the first UE 121, or the group of UEs 120, 121, should perform MDT measurements filtered according to the filtering criteria.

Embodiment 22. The RAN node 110 according to any of the Embodiments 19-21, wherein the one or more filtering criteria, related to type of network support and/or UE characteristic and/or level of granularity, are adapted to relate to any one or more out of:
a High Speed Data Network, HSDN, and/or indications or conditions pertaining to speed,
an NR-R or NR-Railway indication,
a UE type or UE category,
a Closed Subscribed Group CSG,
Mobility Restrictions,
a Type of Core Network e.g. EPC or 5GC
a Non-Public Network,
a Public Warning System PWS,
an Integrated Access and Backhaul, IAB,
a Slice, e.g. one or a list of S-NSSAIs, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
an Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT,

Embodiment 23. The RAN node 110 according to any of the Embodiments 19-22, wherein the MDT configuration is adapted to further comprise to apply the MDT measurement and send the MDT measurement report according to any one or more out of:
per MDT mode,
per MDT measurements,
per “Area Scope of MDT” value, and
per “event configuration”

Embodiment 24. The RAN node 110 according to any of the Embodiments 19-23, further configured to:
receive e.g. by means of a receiving unit in the RAN node 110, a report from the first UE 121, or the group of UEs 120, 121, reporting an MDT measurement measured according to the filtering criteria sent to the first UE 121, or the group of UEs 120, 121.

Embodiment 25. The RAN node 110 according to Embodiment 24, wherein the report is adapted to further comprise the filtering criteria used for filtering the reported MDT measurement.

Embodiment 26. A User Equipment, UE, 121, e.g. also referred to as the first UE 121, e.g. configured to handle a Minimization of Drive Tests MDT measurement in a wireless communications network 100, the UE 121 e.g. being further configured to any one or more out of:
receive, e.g. by means of a receiving unit in the UE 121, an MDT configuration from a Radio Access Node, RAN, node 110, an MDT configuration comprising one or more parameters, which one or more parameters are adapted to comprise respective one or more filtering criteria related to type of network support and/or UE characteristic and/or level of granularity, to be used by the UE 121 for performing MDT measurements, which MDT configuration is adapted to configure the UE 121 to measure and report MDT measurements according to said filtering criteria.

Embodiment 27. The UE 121 according to Embodiment 26, wherein the MDT configuration is adapted to further configure the UE 121 e.g. to evaluate, to determine whether and/or when the UE 121 should perform MDT measurements filtered according to the filtering criteria.

Embodiment 28. The UE 121 according to any of the Embodiments 26-27, further configured to:
evaluate, e.g. by means of an evaluating unit in the UE 121, to decide whether and/or when the UE 121 shall perform MDT measurements filtered according to the filtering criteria.

Embodiment 29. The UE 121 according to any of the Embodiments 26-28, further configured to:
perform, e.g. by means of a performing unit in the UE 121, an MDT measurement measured according to the filtering criteria, and
send, e.g. by means of a sending unit in the UE 121, a report to the RAN, node 110, reporting the MDT measurement measured according to the filtering criteria.

Embodiment 30. The UE 121 according to Embodiment 29, wherein the report is adapted to further comprise the filtering criteria used for filtering the reported MDT measurement.

Embodiment 31. The UE 121 according to any of the Embodiments 26-30, wherein the one or more filtering criteria, related to type of network support and/or UE characteristic and/or level of granularity, are adapted to relate to any one or more out of:
a High Speed Data Network, HSDN, and/or indications or conditions pertaining to speed,
an NR-R or NR-Railway indication,
a UE type or UE category,
a Closed Subscribed Group CSG,
Mobility Restrictions,
a Type of Core Network e.g. EPC or 5GC
a Non-Public Network,
a Public Warning System PWS,
an Integrated Access and Backhaul, IAB,
a Slice, e.g. one or a list of S-NSSAIs, or a part of an S-NSSAI, such as a Slice/Service Type, SST, or a Slice Differentiator, SD,
a Radio Bearer or Radio Bearer Type,
a Cell type attribute,
a Connectivity mode,
a Duplex mode,
a Radio Access Technology, RAT,
Multicast and/or Broadcast e.g. MBMS,
NB-Internet of Things, IoT,
Operation in unlicensed spectrum e.g. NR-U,
Non-Terrestrial Network, NTN,
a Geographical area definition,
a Radio Resource Control, RRC, state,
transition(s) among Radio Resource Control, RRC, states
a Resource coordination and interference mitigation in the cells,
Area scope definitions e.g. Cell based, TA based, TAI based including logical expressions,
Combinations of existing area scope definition means/possibilities, and
Configurations or usage of network features others than MDT,

Embodiment 32. The UE 121 according to any of the Embodiments 26-31, wherein the MDT configuration is adapted to further comprise, to apply the MDT measurement and to send the MDT measurement report according to any one or more out of:
per MDT mode,
per MDT measurements,
per “Area Scope of MDT” value, and
per “event configuration”

### ABBREVIATION EXPLANATION

3G 3rd Generation
3GP A multimedia container format defined by 3GPP for 3G UMTS multimedia services
3GPP 3rd Generation Partnership Project
5GCN 5G Core Network
5GS 5G System
AF Application Function
AHS Adaptive HTTP Streaming
AMF Access and Mobility Management Function
AN Access Network
API Application Programming Interface
AR Augmented Reality
CA Carrier Aggregation
CGI Cell Global Identity
CHO Conditional Handover
CN Core Network
CP Control Plane
CPC Conditional PSCell Change
CR Change Request
CL Central Unit
DASH Dynamic Adaptive Streaming over HTTP
DAPS Dual Active Protocol Stacks
DC Dual Connectivity
DM Device Manager
DU Distributed Unit
EM Element Manager
eNB E-UTRAN Node B/Evolved Node B
EN-DC E-UTRA-NR Dual Connectivity
E-UTRA Evolved UTRA
E-UTRAN Evolved UTRAN
gNB Radio base station in NR
HTTP Hypertext Transfer Protocol
ID Identifier/Identity
IE Information Element
IEC International Electrotechnical Commission
IMS IP Multimedia Subsystem
IP Internet Protocol
ISC International Organization for Standardization
LAI Location Area Identity
LTE Long Term Evolution
MBS Multicast Broadcast Service
MCE Measurement Collector Entity
MME Mobility Management Entity
MN Master Node
MPD Media Presentation Description
MR-DCMulti-Radio Dual Connectivity
MTSI Mobility Telephony Service for IMS
NE-DC NR-E-UTRA Dual Connectivity
NEF Network Exposure Function
NG Next Generation
NGEN-DC NG-RAN E-UTRA-NR Dual Connectivity
NG-RAN NG Radio Access Network
NM Network Manager
NR New Radio
O&M Operation and Maintenance
PCell Primary Cell
PCF Policy Control Function
PCI Physical Cell Identity
PLMN Public Land Mobile Network
PSCell Primary Secondary Cell
QCI QoS Class Identifier
QMC QoE Measurement Collection
QoE Quality of Experience
QoE CE QoE Collector Entity
QoS Quality of Service
RACH Random Access Channel
RAI Routing Area Identity
RAN Radio Access Network
RAN2 TSG-RAN WG2
RAN3 TSG-RAN WG3
RAT Radio Access Technology
RRC Radio Resource Control
RSRP Reference Signal Received Power
RSRQ Reference Signal Received Quality
RSSI Received Signal Strength Indicator
RVQoE/RV-QoE RAN Visible QoE
S1 The interface between the RAN and the CN in LTE.
S1AP S1 Application Protocol
SCell Secondary Cell
SCG Secondary Cell Group
SINR Signal to Interference and Noise Ratio
SMF Session Management Function
SMO Service Management and Orchestration
SN Secondary Node
SNR Signal to Noise Ratio
S-NSSAI Single Network Slice Selection Assistance Information
SRB Signaling Radio Bearer
TAC Tracking Area Code
TCE Trace Collector Entity
TS Technical Specification
TSG Technical Specification Group
UE User Equipment
UMTS Universal Mobile Telecommunication System
UP User Plane
URL Universal Resource Locator
URLLC Ultra-Reliable Low-Latency Communication
UTRA Universal Terrestrial Radio Access
UTRAN Universal Terrestrial Radio Access Network
VR Virtual Reality
WG Working Group

### Further Extensions and Variations

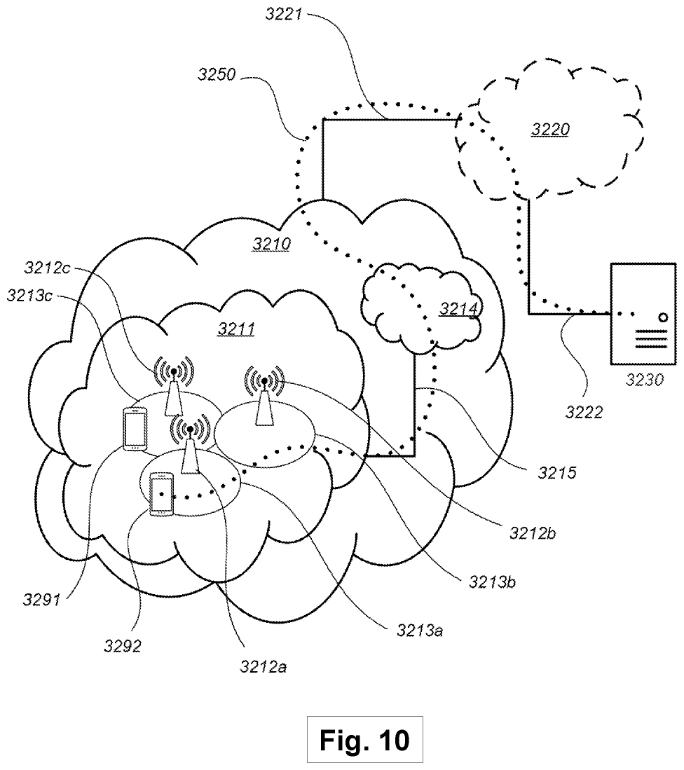

With reference to FIG. 10, in accordance with an embodiment, a communication system includes a telecommunication network 3210 such as the wireless communication network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the RAN node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE e.g. the UE 121, such as a Non-AP STA 3291 located in coverage area 3213c is configured to wirelessly connect to, or be paged by, the corresponding base station 3212c. A second UE 3292 e.g. an of the UEs in the group of UEs 120, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

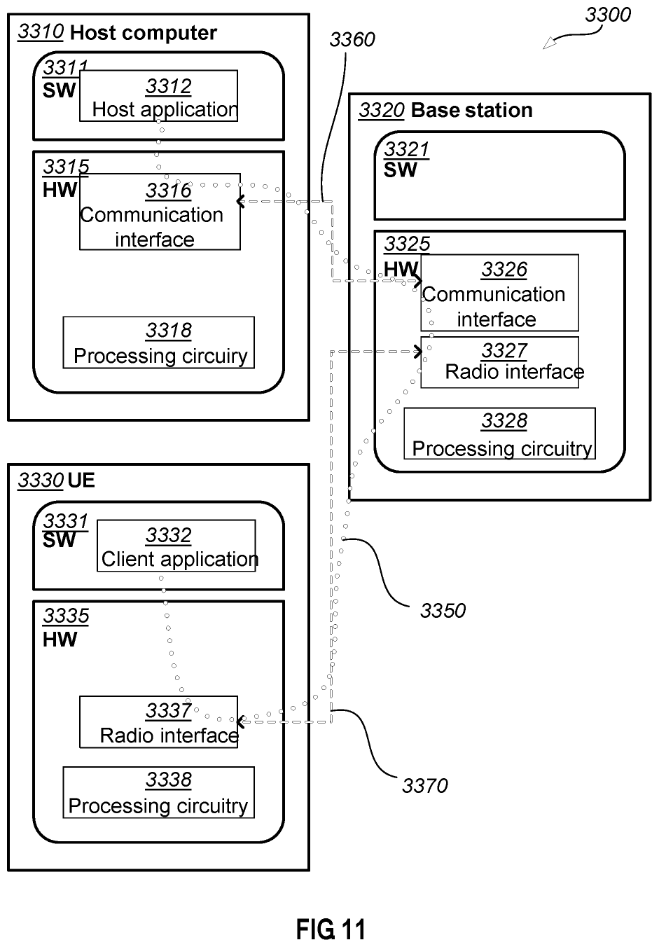

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

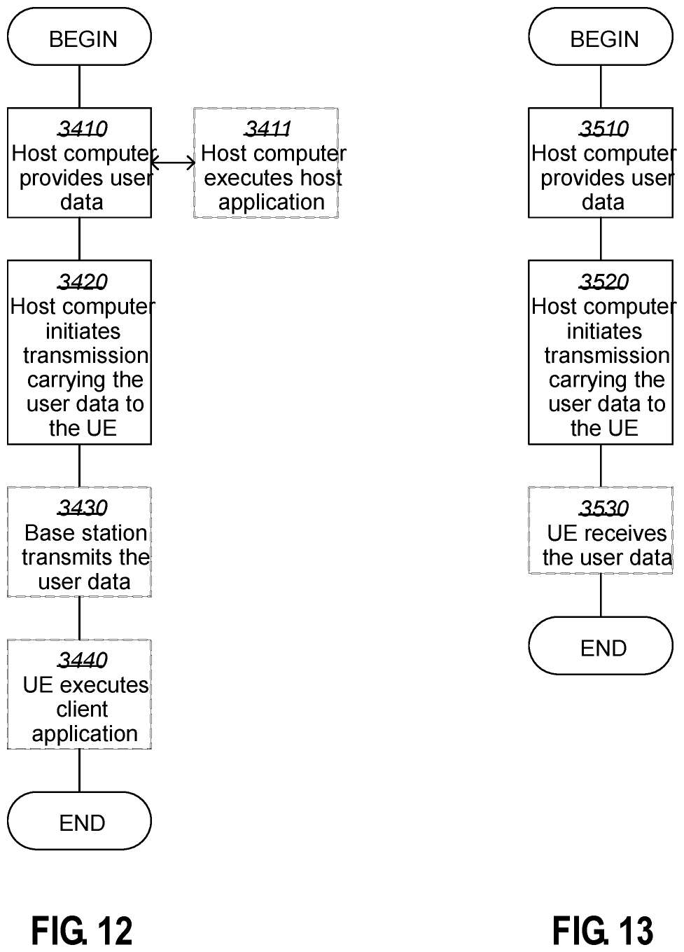

FIG. 12 is a flowchart illustrating a method implemented in a communication system, in accordance with one embodiment. The communication system includes a host computer, a base station such as the RAN node 110, and a UE such as the UE 121, which may be those described with reference to FIG. 10 and FIG. 11. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

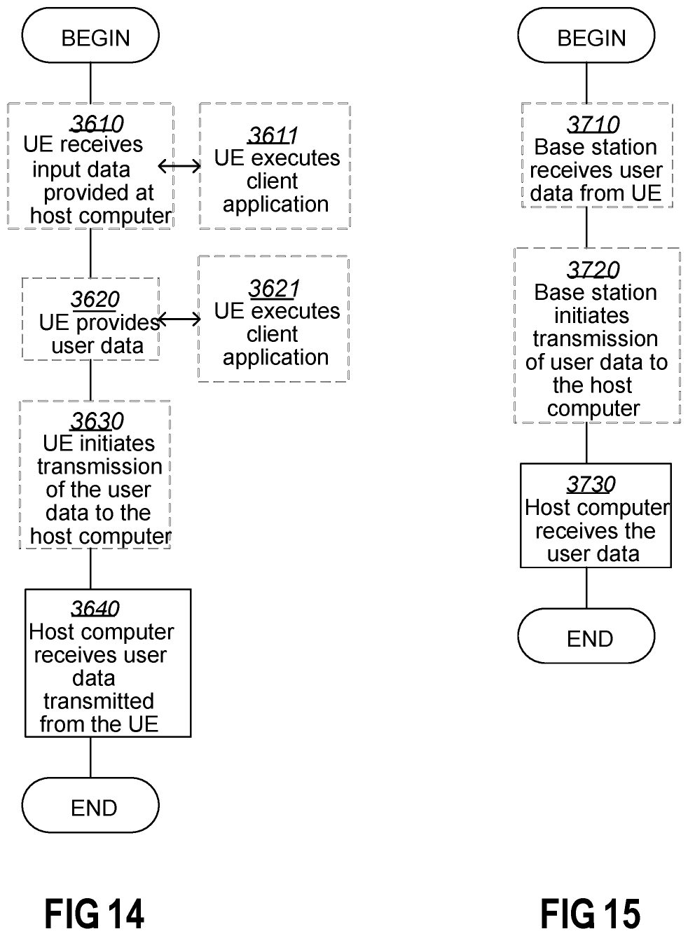

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a Radio Access Node, RAN, node for controlling a Minimization of Drive Tests, MDT, measurement to be performed by a User Equipment, UE, or a group of UEs in a wireless communications network, the method comprising:
obtaining, a set of parameters of an MDT configuration, which set of parameters comprises respective one or more filtering criteria related to type of network support and/or UE characteristic and/or level of granularity, to be used by UEs for performing MDT measurements,
sending to a first UE or a group of UEs comprising the first UE, an MDT configuration comprising, one or more parameters, which one or more parameters comprises at least a part of the parameters comprised in the set of parameters, which MDT configuration configures the first UE, or the group of UEs, to measure and report MDT measurements according to said filtering criteria.

2. The method according to claim 1, further comprising:
based on the obtained set of parameters, selecting the first UE, or the group of UEs, that is capable of measuring and reporting MDT according to the filtering criteria.

3. The method according to claim 1, wherein the MDT configuration further configures the first UE, or the group of UEs, to evaluate, to determine whether and/or when the first UE, or the group of UEs, should perform MDT measurements filtered according to the filtering criteria.

4. The method according to claim 1, wherein the one or more filtering criteria, related to type of network support and/or UE characteristic and/or level of granularity, relate to any one or more out of:
a High Speed Data Network, HSDN, and/or indications or conditions pertaining to speed,
a value or range of values of UE velocity,
an NR-R (or NR-Railway) indication,
a UE type or UE category,
a Closed Subscribed Group, CSG,
Mobility Restrictions,
a Type of Core Network
a Non-Public Network,
a Public Warning System, PWS,
an Integrated Access and Backhaul, IAB,
a Slice,
a Radio Bearer or Radio Bearer Type,
a Cell type attribute,
a Connectivity mode,
a Duplex mode,
a Radio Access Technology, RAT,
Multicast and/or Broadcast,
NB-Internet of Things, IoT,
Operation in unlicensed spectrum,
Non-Terrestrial Network, NTN,
a Geographical area definition,
a Radio Resource Control, RRC, state,
transition(s) among Radio Resource Control, RRC, states
a Resource coordination and interference mitigation in the cells,
Area scope definitions including logical expressions,
Combinations of existing area scope definition means/possibilities, and
Configurations or usage of network features others than MDT,

5. The method according to claim 1, wherein the MDT configuration further comprises to apply the MDT measurement and send the MDT measurement report according to any one or more out of:
per MDT mode,
per MDT measurements,
per “Area Scope of MDT” value, and
per “event configuration”

6. The method according to claim 1, further comprising:
receiving a report from the first UE, or the group of UEs, reporting an MDT measurement measured according to the filtering criteria sent to the first UE, or the group of UEs.

7. The method according to claim 6, wherein the report further comprises the filtering criteria used for filtering the reported MDT measurement.

8. The method according to claim 1, wherein:
the set of parameters of an MDT configuration is obtained from a network node.

9-10. (canceled)

11. A method performed by a User Equipment, UE, for handling a Minimization of Drive Tests (MDT) measurement in a wireless communications network, the method comprising:
receiving an MDT configuration from a Radio Access Node, RAN, node, an MDT configuration comprising one or more parameters comprising respective one or more filtering criteria related to type of network support and/or UE characteristic and/or level of granularity, to be used by the UE for performing MDT measurements, which MDT configuration configures the UE to measure and report MDT measurements according to said filtering criteria.

12. The method according to claim 10, wherein the MDT configuration further configures the UE to evaluate, to determine whether and/or when the UE should perform MDT measurements filtered according to the filtering criteria.

13. The method according to claim 10, further comprising:
evaluating to decide whether and/or when the UE shall perform MDT measurements filtered according to the filtering criteria.

14-19. (canceled)

20. A Radio Access Node, RAN, node configured to control a Minimization of Drive Tests, MDT, measurement to be performed by a User Equipment, UE, or a group of UEs in a wireless communications network, the RAN node being further configured to:
obtain units a set of parameters of an MDT configuration, which set of parameters is adapted to comprise respective one or more filtering criteria related to type of network support and/or UE characteristic and/or level of granularity, to be used by UEs for performing MDT measurements,
send to a first UE or a group of UEs comprising the first UE, an MDT configuration comprising, one or more parameters, which one or more parameters are adapted to comprise at least a part of the parameters comprised in the set of parameters, which MDT configuration is adapted to configure the first UE, or the group of UEs, to measure and report MDT measurements according to said filtering criteria.

21. The RAN node according to claim 19, further configured to:
based on the obtained set of parameters, select the first UE, or the group of UEs, that is capable of measuring and reporting MDT according to the filtering criteria.

22. The RAN node according to claim 19, wherein the MDT configuration is adapted to further configure the first UE, or the group of UEs to evaluate, to determine whether and/or when the first UE, or the group of UEs, should perform MDT measurements filtered according to the filtering criteria.

23. The RAN node according to claim 19, wherein the one or more filtering criteria, related to type of network support and/or UE characteristic and/or level of granularity, are adapted to relate to any one or more out of:
a High Speed Data Network, HSDN, and/or indications or conditions pertaining to speed,
a value or range of values of UE velocity,
an NR-R (or NR-Railway) indication,
a UE type or UE category,
a Closed Subscribed Group, CSG,
Mobility Restrictions,
a Type of Core Network,
a Non-Public Network,
a Public Warning System, PWS,
an Integrated Access and Backhaul, IAB,
a Slice,
a Radio Bearer or Radio Bearer Type,
a Cell type attribute,
a Connectivity mode,
a Duplex mode,
a Radio Access Technology, RAT,
Multicast and/or Broadcast,
NB-Internet of Things, IoT,
Operation in unlicensed spectrum,
Non-Terrestrial Network, NTN,
a Geographical area definition,
an Radio Resource Control, RRC, state,
a Resource coordination and interference mitigation in the cells,
Area scope definitions including logical expressions,
Combinations of existing area scope definition means/possibilities, and
Configurations or usage of network features others than MDT,

24. The RAN node according to claim 19, wherein the MDT configuration is adapted to further comprise to apply the MDT measurement and send the MDT measurement report according to any one or more out of:
per MDT mode,
per MDT measurements,
per “Area Scope of MDT” value, and
per “event configuration”

25. The RAN node according to claim 19, further configured to:
receive a report from the first UE, or the group of UEs, reporting an MDT measurement measured according to the filtering criteria sent to the first UE, or the group of UEs.

26. The RAN node according to claim 24, wherein the report is adapted to further comprise the filtering criteria used for filtering the reported MDT measurement.

27. The RAN node according to claim 20 wherein:
The set of parameters of an MDT configuration is obtained from a network node.

28. A User Equipment, UE, configured to handle a Minimization of Drive Tests (MDT) measurement in a wireless communications network, the UE being further configured to:
receive an MDT configuration from a Radio Access Node, RAN, node, an MDT configuration comprising one or more parameters, which one or more parameters are adapted to comprise respective one or more filtering criteria related to type of network support and/or UE characteristic and/or level of granularity, to be used by the UE for performing MDT measurements, which MDT configuration is adapted to configure the UE to measure and report MDT measurements according to said filtering criteria.

29. The UE according to claim 26, wherein the MDT configuration is adapted to further configure the UE to evaluate, to determine whether and/or when the UE should perform MDT measurements filtered according to the filtering criteria.

30. The UE according to claim 26, further configured to:
evaluate to decide whether and/or when the UE shall perform MDT measurements filtered according to the filtering criteria.

31. The UE according to claim 26, further configured to:
perform an MDT measurement measured according to the filtering criteria, and
send a report to the RAN, node, reporting an MDT measurement measured according to the filtering criteria.

32. The UE according to claim 29, wherein the report is adapted to further comprise the filtering criteria used for filtering the reported MDT measurement.

33. The UE according to claim 26, wherein the one or more filtering criteria, related to type of network support and/or UE characteristic and/or level of granularity, are adapted to relate to any one or more out of:
a High Speed Data Network, HSDN, and/or indications or conditions pertaining to speed,
a value or range of values of UE velocity,
an NR-R (or NR-Railway) indication,
a UE type or UE category,
a Closed Subscribed Group, CSG,
Mobility Restrictions,
a Type of Core Network,
a Non-Public Network,
a Public Warning System, PWS,
an Integrated Access and Backhaul, IAB,
a Slice,
a Radio Bearer or Radio Bearer Type,
a Cell type attribute,
a Connectivity mode,
a Duplex mode,
a Radio Access Technology, RAT,
Multicast and/or Broadcast,
NB-Internet of Things, IoT,
Operation in unlicensed spectrum,
Non-Terrestrial Network, NTN,
a Geographical area definition,
an Radio Resource Control, RRC, state,
a Resource coordination and interference mitigation in the cells,
Area scope definitions including logical expressions,
Combinations of existing area scope definition means/possibilities, and
Configurations or usage of network features others than MDT,

34. The UE according to claim 26, wherein the MDT configuration is adapted to further comprise, to apply the MDT measurement and to send the MDT measurement report according to any one or more out of:
per MDT mode,
per MDT measurements,
per “Area Scope of MDT” value, and
per “event configuration”.
